(19) United States
(12) Patent Application Publication
(10) Pub. No.: US 2018/0068611 A1
(43) Pub. Date: Mar. 8, 2018

(54) PIXELS AND REFERENCE CIRCUITS AND TIMING TECHNIQUES

(71) Applicant: Ignis Innovation Inc., Waterloo (CA)

(72) Inventors: Gholamreza Chaji, Waterloo (CA); Yaser Azizi, Waterloo (CA); Arash Moradi, Waterloo (CA); Hongxin Liu, Cambridge (CA)

(21) Appl. No.: 15/797,661

(22) Filed: Oct. 30, 2017

Related U.S. Application Data
(63) Continuation-in-part of application No. 15/361,660, filed on Nov. 28, 2016.
Application No. 15/361,660 is a continuation-in-part of application No. 15/215,036, filed on Jul. 20, 2016.

(30) Foreign Application Priority Data
Jul. 24, 2015 (CA) 2898282

(51) Int. Cl. G09G 3/325

(52) U.S. Cl. CPC G09G 3/325; G09G 2320/0233; G09G 2310/08; G09G 2320/0693

(57) ABSTRACT

What is disclosed are systems and methods of compensation of images produced by active matrix light emitting diode device (AMOLED) and other emissive displays. Anomalies in luminance produced by pixel circuits and bias currents produced by current biasing circuits for driving current biased voltage programmed pixels are corrected through calibration and compensation while re-using existing data or other lines that can be controlled individually to perform said calibration and compensation.

### PRIORITY CLAIM

This application is a continuation-in-part of U.S. patent application Ser. No. 15/361,660, filed Nov. 28, 2016, which is a continuation-in-part of U.S. patent application Ser. No. 15/215,036, filed Jul. 20, 2016, which claims priority to Canadian Application No. 2,898,282, filed Jul. 24, 2015, each of which is hereby incorporated by reference herein in its entirety.

### FIELD OF THE INVENTION

The present disclosure relates to pixels, current biasing, and signal timing of light emissive visual display technology, and particularly to systems and methods for programming and calibrating pixels and pixel current biasing in active matrix light emitting diode device (AMOLED) and other emissive displays.

### BRIEF SUMMARY

Accordingly, the present disclosure relates to display system, including a plurality of pixels, comprising:

a controller for receiving digital data indicative of information to be displayed on the display system;

a source driver for receiving data from the controller and for transmitting data signals to each pixel during a programming phase, and including a monitoring system integrated therewith for measuring a current or voltage associated with each pixel for extracting information indicative of a degradation of each pixel during a measurement phase;

a plurality of combined data/monitor lines extending from the source driver for transmitting both data and monitor signals during alternating programming and measurement phases, respectively;

a plurality of data lines extending to each pixel;

a plurality of monitor lines extending to each pixel for measuring a current or voltage associated with each pixel after the programming phase; and

a switching system for alternatively connecting each combined data/monitor line with one of the data lines and one of the monitor lines.

### BRIEF DESCRIPTION OF THE DRAWINGS

The foregoing and other advantages of the disclosure will become apparent upon reading the following detailed description and upon reference to the drawings.

FIG. 1 illustrates an example display system utilizing the methods and comprising the pixels and current biasing elements disclosed;

FIG. 2 is a circuit diagram of a current sink according to one embodiment;

FIG. 3 is a timing diagram of current sink and source programming and calibration according to one embodiment;

FIG. 4 is a circuit diagram of a current source according to a further embodiment;

FIG. 5 is a circuit diagram of a 4T1C pixel circuit according to an embodiment;

FIG. 6A is a timing diagram illustrating a programming and driving of a 4T1C pixel circuit;

FIG. 6B is a timing diagram illustrating a programming and measuring of a 4T1C pixel circuit;

FIG. 7 is a circuit diagram of a 6T1C pixel circuit according to an embodiment;

FIG. 8A is a timing diagram illustrating a programming and driving of a 6T1C pixel circuit;

FIG. 8B is a timing diagram illustrating a programming and measuring of a 6T1C pixel circuit;

FIG. 9 is a timing diagram for improved driving of rows of pixels;

FIG. 10 is a circuit diagram of a 4T1C pixel circuit operated in current mode according to an embodiment;

FIG. 11 is a circuit diagram of a 6T1C pixel circuit operated in current mode according to an embodiment;

FIG. 12 is a timing diagram illustrating a programming and driving of 4T1C and 6T1C pixel circuits of FIG. 10 and FIG. 11.

FIG. 13 is a circuit diagram of a 4T1C reference current sink according to an embodiment;

FIG. 14 is a circuit diagram of a 6T1C reference current sink according to an embodiment;

FIG. 15 is a circuit diagram of a 4T1C reference current source according to an embodiment;

FIG. 16 is a circuit diagram of a 6T1C reference current source according to an embodiment;

FIG. 17 is a reference row timing diagram illustrating a programming and driving of 4T1C, 6T1C, sinks and sources of FIGS. 13, 14, 15, and 16;

FIG. 18 is a schematic diagram of on-panel multiplexing of data and monitor lines;

FIG. 19 is a schematic diagram of on-panel multiplexing of data and monitor lines;

FIG. 20 is a timing diagram illustrating a programming a driving of pixel circuits of FIG. 19; and

FIG. 21 is a schematic diagram of modified on-panel multiplexing of data and monitor lines, in which two pixels are programmed in a single cycle.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Many modern display technologies suffer from defects, variations, and non-uniformities, from the moment of fabrication, and can suffer further from aging and deterioration over the operational lifetime of the display, which result in the production of images which deviate from those which are intended. Methods of image calibration and compensation are used to correct for those defects in order to produce images which are more accurate, uniform, or otherwise more closely reproduce the image represented by the image data. Some displays utilize a current-bias voltage-programming driving scheme, each of its pixels being a current-biased voltage-programmed (CBVP) pixel. In such displays a further requirement for producing and maintaining accurate image reproduction is that the current biasing elements, that is the current sources or sinks, which provide current biasing provide the appropriate level of current biasing to those pixels.

Due to unavoidable variations in fabrication and variations in degradation through use, a number of current biasing elements provided for a display and pixels of the display, although designed to be uniformly and exactly alike and programmed to provide the desired current biasing level and respectively desired luminance, in fact exhibit deviations in current biasing and respectively luminance provided. In order to correct for visual defects that would otherwise arise from the non-uniformity and inaccuracies of these current sources or sinks and the pixels, the programming of the current biasing elements and pixels are augmented with calibration and optionally monitoring and compensation.

As the resolution of an array semiconductor device increases, the number of lines and elements required to drive, calibrate, and/or monitor the array increases dramatically. This can result in higher power consumption, higher manufacturing costs, and a larger physical foot print. In the case of a CBVP pixel display, providing circuitry to program, calibrate, and monitor current sources or sinks can increase cost and complexity of integration as the number of rows or columns increases.

The systems and methods disclosed below address these issues through control timing and calibration of pixel circuits and a family of current biasing elements while utilizing circuits which are integrated on the display in a manner which use existing display components.

While the embodiments described herein will be in the context of AMOLED displays it should be understood that the systems and methods described herein are applicable to any other display comprising pixels which might utilize current biasing, including but not limited to light emitting diode displays (LED), electroluminescent displays (ELD), organic light emitting diode displays (OLED), plasma display panels (PSP), among other displays.

It should be understood that the embodiments described herein pertain to systems and methods of calibration and compensation and do not limit the display technology underlying their operation and the operation of the displays in which they are implemented. The systems and methods described herein are applicable to any number of various types and implementations of various visual display technologies.

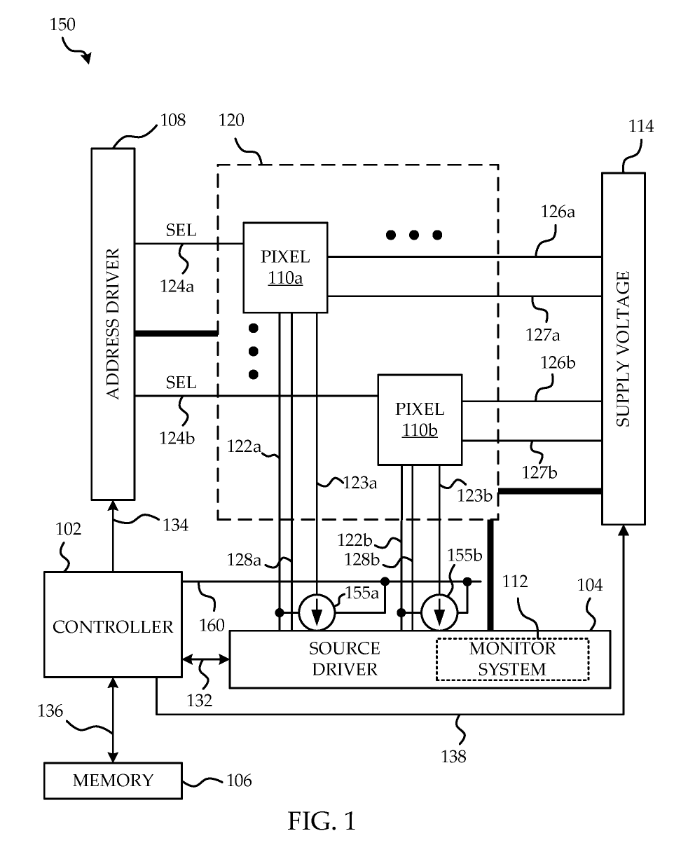

FIG. 1 is a diagram of an example display system 150 implementing the methods and comprising the circuits described further below. The display system 150 includes a display panel 120, an address driver 108, a source driver 104, a controller 102, and a memory storage 106.

The display panel 120 includes an array of pixels 110a 110b (only two explicitly shown) arranged in rows and columns. Each of the pixels 110a 110b is individually programmable to emit light with individually programmable luminance values and is a current biased voltage programmed pixel (CBVP). The controller 102 receives digital data indicative of information to be displayed on the display panel 120. The controller 102 sends signals 132 to the source driver 104 and scheduling signals 134 to the address driver 108 to drive the pixels 110 in the display panel 120 to display the information indicated. The plurality of pixels 110 of the display panel 120 thus comprise a display array or display screen adapted to dynamically display information according to the input digital data received by the controller 102. The display screen can display images and streams of video information from data received by the controller 102. The supply voltage 114 provides a constant power voltage or can serve as an adjustable voltage supply that is controlled by signals from the controller 102. The display system 150 incorporates features from current biasing elements 155a, 155b, either current sources or sinks (current sinks are shown) to provide biasing currents to the pixels 110a 110b in the display panel 120 to thereby decrease programming time for the pixels 110. Although shown separately from the source driver 104, current biasing elements 155a, 155b may form part of the source driver 104 or may be integrated as separate elements. It is to be understood that the current biasing elements 155a, 155b used to provide current biasing to the pixels may be current sources rather than current sinks depicted in FIG. 1.

For illustrative purposes, only two pixels 110a, 110b are explicitly shown in the display system 150 in FIG. 1. It is understood that the display system 150 is implemented with a display screen that includes an array of pixels, such as the pixels 110a, 110b, and that the display screen is not limited to a particular number of rows and columns of pixels. For example, the display system 150 can be implemented with a display screen with a number of rows and columns of pixels commonly available in displays for mobile devices, monitor-based devices, and/or projection-devices. In a multichannel or color display, a number of different types of pixels, each responsible for reproducing color of a particular channel or color such as red, green, or blue, will be present in the display. Pixels of this kind may also be referred to as “subpixels” as a group of them collectively provide a desired color at a particular row and column of the display, which group of subpixels may collectively also be referred to as a “pixel”.

Each pixel 110a, 110b is operated by a driving circuit or pixel circuit that generally includes a driving transistor and a light emitting device. Hereinafter the pixel 110a, 110b may refer to the pixel circuit. The light emitting device can optionally be an organic light emitting diode, but implementations of the present disclosure apply to pixel circuits having other electroluminescence devices, including current-driven light emitting devices and those listed above. The driving transistor in the pixel 110a, 110b can optionally be an n-type or p-type amorphous silicon thin-film transistor, but implementations of the present disclosure are not limited to pixel circuits having a particular polarity of transistor or only to pixel circuits having thin-film transistors. The pixel circuit 110a, 110b can also include a storage capacitor for storing programming information and allowing the pixel circuit 110 to drive the light emitting device after being addressed. Thus, the display panel 120 can be an active matrix display array.

As illustrated in FIG. 1, each of the pixels 110a, 110b in the display panel 120 are coupled to a respective select line 124a, 124b, a respective supply line 126a, 126b, a respective data line 122a, 122b, a respective current bias line 123a, 123b, and a respective monitor line 128a, 128b. A read line may also be included for controlling connections to the monitor line. In one implementation, the supply voltage 114 can also provide a second supply line to each pixel 110a, 110b. For example, each pixel can be coupled to a first supply line 126a, 126b charged with Vdd and a second supply line 127a, 127b coupled with Vss, and the pixel circuits 110a, 110b can be situated between the first and second supply lines to facilitate driving current between the two supply lines during an emission phase of the pixel circuit. It is to be understood that each of the pixels 110 in the pixel array of the display 120 is coupled to appropriate select lines, supply lines, data lines, and monitor lines. It is noted that aspects of the present disclosure apply to pixels having additional connections, such as connections to additional select lines, and to pixels having fewer connections, and pixels sharing various connections.

With reference to the pixel 110a of the display panel 120, the select line 124a is provided by the address driver 108, and can be utilized to enable, for example, a programming operation of the pixel 110a by activating a switch or transistor to allow the data line 122a to program the pixel 110a. The data line 122a conveys programming information from the source driver 104 to the pixel 110a. For example, the data line 122a can be utilized to apply a programming voltage or a programming current to the pixel 110a in order to program the pixel 110a to emit a desired amount of luminance. The programming voltage (or programming current) supplied by the source driver 104 via the data line 122a is a voltage (or current) appropriate to cause the pixel 110a to emit light with a desired amount of luminance according to the digital data received by the controller 102. The programming voltage (or programming current) can be applied to the pixel 110a during a programming operation of the pixel 110a so as to charge a storage device within the pixel 110a, such as a storage capacitor, thereby enabling the pixel 110a to emit light with the desired amount of luminance during an emission operation following the programming operation. For example, the storage device in the pixel 110a can be charged during a programming operation to apply a voltage to one or more of a gate or a source terminal of the driving transistor during the emission operation, thereby causing the driving transistor to convey the driving current through the light emitting device according to the voltage stored on the storage device. Current biasing element 155a provides a biasing current to the pixel 110a over the current bias line 123a in the display panel 120 to thereby decrease programming time for the pixel 110a. The current biasing element 155a is also coupled to the data line 122a and uses the data line 122a to program its current output when not in use to program the pixels, as described hereinbelow. In some embodiments, the current biasing elements 155a, 155b are also coupled to a reference/monitor line 160 which is coupled to the controller 102, for monitoring and controlling of the current biasing elements 155a, 155b.

Generally, in the pixel 110a, the driving current that is conveyed through the light emitting device by the driving transistor during the emission operation of the pixel 110a is a current that is supplied by the first supply line 126a and is drained to a second supply line 127a. The first supply line 126a and the second supply line 127a are coupled to the voltage supply 114. The first supply line 126a can provide a positive supply voltage (e.g., the voltage commonly referred to in circuit design as “Vdd”) and the second supply line 127a can provide a negative supply voltage (e.g., the voltage commonly referred to in circuit design as “Vss”). Implementations of the present disclosure can be realized where one or the other of the supply lines (e.g., the supply line 127a) is fixed at a ground voltage or at another reference voltage.

The display system 150 also includes a monitoring system 112. With reference again to the pixel 110a of the display panel 120, the monitor line 128a connects the pixel 110a to the monitoring system 112. The monitoring system 112 can be integrated with the source driver 104, or can be a separate stand-alone system. In particular, the monitoring system 112 can optionally be implemented by monitoring the current and/or voltage of the data line 122a during a monitoring operation of the pixel 110a, and the monitor line 128a can be entirely omitted. The monitor line 128a allows the monitoring system 112 to measure a current or voltage associated with the pixel 110a and thereby extract information indicative of a degradation or aging of the pixel 110a or indicative of a temperature of the pixel 110a. In some embodiments, display panel 120 includes temperature sensing circuitry devoted to sensing temperature implemented in the pixels 110a, while in other embodiments, the pixels 110a comprise circuitry which participates in both sensing temperature and driving the pixels. For example, the monitoring system 112 can extract, via the monitor line 128a, a current flowing through the driving transistor within the pixel 110a and thereby determine, based on the measured current and based on the voltages applied to the driving transistor during the measurement, a threshold voltage of the driving transistor or a shift thereof. In some embodiments the monitoring system 112 extracts information regarding the current biasing elements via data lines 122a, 122b or the reference/monitor line 160 and in some embodiments, this is performed in cooperation with or by the controller 102.

The monitoring system 112 can also extract an operating voltage of the light emitting device (e.g., a voltage drop across the light emitting device while the light emitting device is operating to emit light). The monitoring system 112 can then communicate signals 132 to the controller 102 and/or the memory 106 to allow the display system 150 to store the extracted aging information in the memory 106. During subsequent programming and/or emission operations of the pixel 110a, the aging information is retrieved from the memory 106 by the controller 102 via memory signals 136, and the controller 102 then compensates for the extracted degradation information in subsequent programming and/or emission operations of the pixel 110a. For example, once the degradation information is extracted, the programming information conveyed to the pixel 110a via the data line 122a can be appropriately adjusted during a subsequent programming operation of the pixel 110a such that the pixel 110a emits light with a desired amount of luminance that is independent of the degradation of the pixel 110a. In an example, an increase in the threshold voltage of the driving transistor within the pixel 110a can be compensated for by appropriately increasing the programming voltage applied to the pixel 110a. In a similar manner, the monitoring system 112 can extract the bias current of a current biasing element 155a. The monitoring system 112 can then communicate signals 132 to the controller 102 and/or the memory 106 to allow the display system 150 to store the extracted information in the memory 106. During subsequent programming of the current biasing element 155a, the information is retrieved from the memory 106 by the controller 102 via memory signals 136, and the controller 102 then compensates for the errors in current previously measured using adjustments in subsequent programming of the current biasing element 155a.

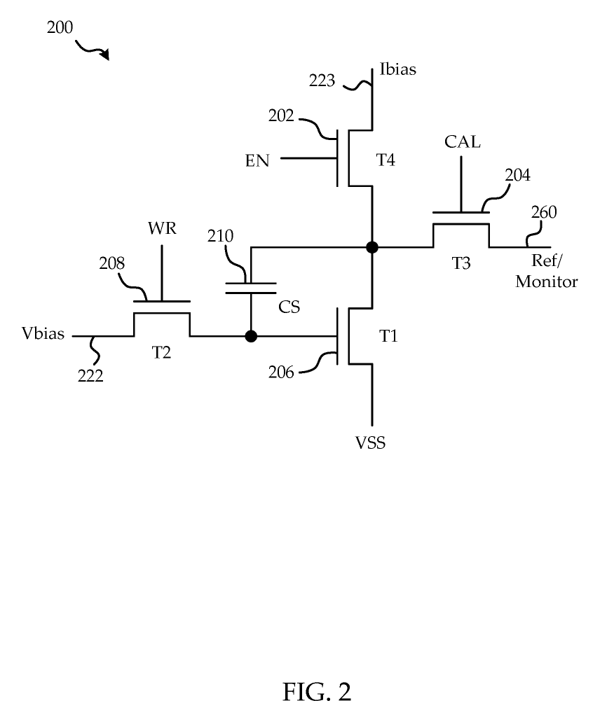

Referring to FIG. 2, the structure of a current sink 200 circuit according to an embodiment will now be described. The current sink 200 corresponds, for example, to a single current biasing element 155a, 155b of the display system 150 depicted in FIG. 1 which provides a bias current Ibias over current bias lines 123a, 123b to a CBVP pixel 110a, 110b. The current sink 200 depicted in FIG. 2 is based on PMOS transistors. A PMOS based current source is also contemplated, structured and functioning according to similar principles described here. It should be understood that variations of this current sink and its functioning are contemplated and include different types of transistors (PMOS, NMOS, or CMOS) and different semiconductor materials (e.g., LTPS, Metal Oxide, etc.).

The current sink 200 includes a first switch transistor 202 (T4) controlled by an enable signal EN coupled to its gate terminal, and being coupled via one of a source and drain terminal to a current bias line 223 (Ibias) corresponding to, for example, a current bias line 123a of FIG. 1, and coupled via the other of the source and drain terminals of the first switch transistor 202 to a first terminal of a storage capacitance 210. A gate terminal of a current drive transistor 206 (T1) is coupled to a second terminal of the storage capacitance 210, while one of the source and gate terminals of the current drive transistor 206 is coupled to the first terminal of the storage capacitance 210. The other of the source and gate terminals of the current drive transistor 206 is coupled to VSS. A gate terminal of a second switch transistor 208 (T2) is coupled to a write signal line (WR), while one of its source and drain terminals is coupled to a voltage bias or data line (Vbias) 222, corresponding, for example, to data line 122a depicted in FIG. 1. The other of the source and drain terminals of the second switch transistor 208 is coupled to the second terminal of the storage capacitance 210. A gate terminal of a third switch transistor 204 (T3) is coupled to a calibration control line (CAL), while one of its source and drain terminals is coupled to a reference monitor line 260, corresponding, for example, to reference monitor line 160 depicted in FIG. 1. The other of the source and drain terminals of the third switch transistor 204 is coupled to the first terminal of the storage capacitance 210. As mentioned above the data lines are shared, being used for providing voltage biasing or data for the pixels during certain time periods during a frame and being used for providing voltage biasing for the current biasing element, here a current sink, during other time periods of a frame. This re-use of the data lines allows for the added benefits of programming and compensation of the numerous individual current sinks using only one extra reference monitoring line 160.

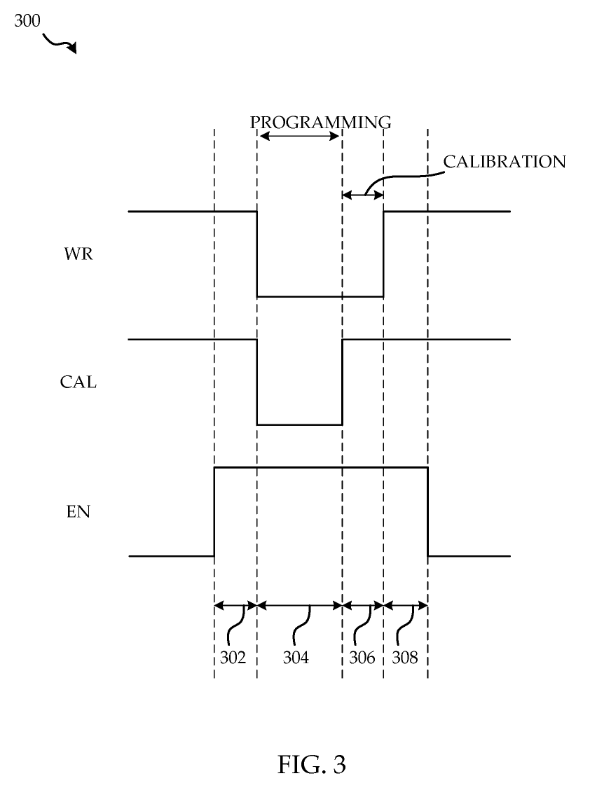

With reference also to FIG. 3, an example of a timing of a current control cycle 300 for programming and calibrating the current sink 200 depicted in FIG. 2 will now be described. The complete control cycle 300 occurs typically once per frame and includes four smaller cycles, a disconnect cycle 302, a programming cycle 304, a calibration cycle 306, and a settling cycle 308. During the disconnect cycle 302, the current sink 200 ceases to provide biasing current Ibias to the current bias line 223 in response to the EN signal going high and the first transistor switch 202 turning off. By virtue of the CAL and WR signals being high, both the second and third switch transistors 208, 204 remain off. The duration of the disconnect cycle 302 also provides a settling time for the current sink 200 circuit. The EN signal remains high throughout the entire control cycle 300, only going low once the current sink 200 circuit has been programmed, calibrated, and settled and is ready to provide the bias current over the current bias line 223. Once the current sink 200 has settled after the disconnect cycle 302 has completed, the programming cycle 304 begins with the WR signal going low turning on the second switch transistor 208 and with the CAL signal going low turning on the third switch transistor 204. During the programming cycle 304 therefore, the third switch transistor 204 connects the reference monitor line 260 over which there is transmitted a known reference signal (can be voltage or current) to the first terminal of the storage capacitance 210, while the second switch transistor 208 connects the voltage bias or data line 222 being input with voltage Vbias to the gate terminal of the current driving transistor 206 and the second terminal of the storage capacitance 210. As a result, the storage capacitance 210 is charged to a defined value. This value is roughly that which is anticipated as necessary to control the current driving transistor 206 to deliver the appropriate current biasing Ibias taking into account optional calibration described below.

After the programming cycle 304 and during the calibration cycle 306, the circuit is reconfigured to discharge some of the voltage (charge) of the storage capacitance 210 though the current driving transistor 206. The calibration signal CAL goes high, turning off the third switch transistor 204 and disconnecting the first terminal of the storage capacitance 210 from the reference monitor line 260. The amount discharged is a function of the main element of the current sink 200, namely the current driving transistor 206 or its related components. For example, if the current driving transistor 206 is “strong”, the discharge occurs relatively quickly and relatively more charge is discharged from the storage capacitance 210 through the current driving transistor 206 during the fixed duration of the calibration cycle 306. On the other hand, if the current driving transistor 206 is “weak”, the discharge occurs relatively slowly and relatively less charge is discharged from the storage capacitance 210 through the current driving transistor 206 during the fixed duration of the calibration cycle 306. As a result the voltage (charge) stored in the storage capacitance 210 is reduced comparatively more for relatively strong current driving transistors versus comparatively less for relatively weak current driving transistors thereby providing some compensation for non-uniformity and variations in current driving transistors across the display whether due to variations in fabrication or variations in degradation over time.

After the calibration cycle 306, a settling cycle 308 is performed prior to provision of the biasing current Ibias to the current bias line 223. During the settling cycle 308, the first and third switch transistors 202, 204 remain off while the WR signal goes high to also turn the second switch transistor 208 off. After completion of the duration of the settling cycle 308, the enable signal EN goes low turning on the first switch transistor 202 and allowing the current driving transistor 206 to sink the Ibias current on the current bias line 223 according to the voltage (charge) stored in the storage capacitance 210, which as mentioned above, has a value which has been drained as a function of the current driving transistor 206 in order to provide compensation for the specific characteristics of the current driving transistor 206.

In some embodiments, the calibration cycle 306 is eliminated. In such a case, the compensation manifested as a change in the voltage (charge) stored by the storage capacitance 210 as a function of the characteristics of the current driving transistor 206 is not automatically provided. In such a case a form of manual compensation may be utilized in combination with monitoring.

In some embodiments, after a current sink 200 has been programmed, and prior to providing the biasing current over the current bias line 223, the current of the current sink 200 is measured through the reference monitor line 260 by controlling the CAL signal to go low, turning on the third switch transistor 204. As illustrated in FIG. 1, in some embodiments the reference monitor line 160 is shared and hence during measurement of the current sink 200 of interest all other current sinks are programmed or otherwise controlled such that they do not source or sink any current on the reference monitor line 160. Once the current of the current sink 200 has been measured in response to known programming of the current sink 200 and possibly after a number of various current measurements in response to various programming values have been measured and stored in memory 106, the controller 102 and memory 106 (possibly in cooperation with other components of the display system 150) adjusts the voltage Vbias used to program the current sink 200 to compensate for the deviations from the expected or desired current sinking exhibited by the current sink 200. This monitoring and compensation, need not be performed every frame and can be performed in a periodic manner over the lifetime of the display to correct for degradation of the current sink 200.

In some embodiments a combination of calibration and monitoring and compensation is used. In such a case the calibration can occur every frame in combination with periodic monitoring and compensation.

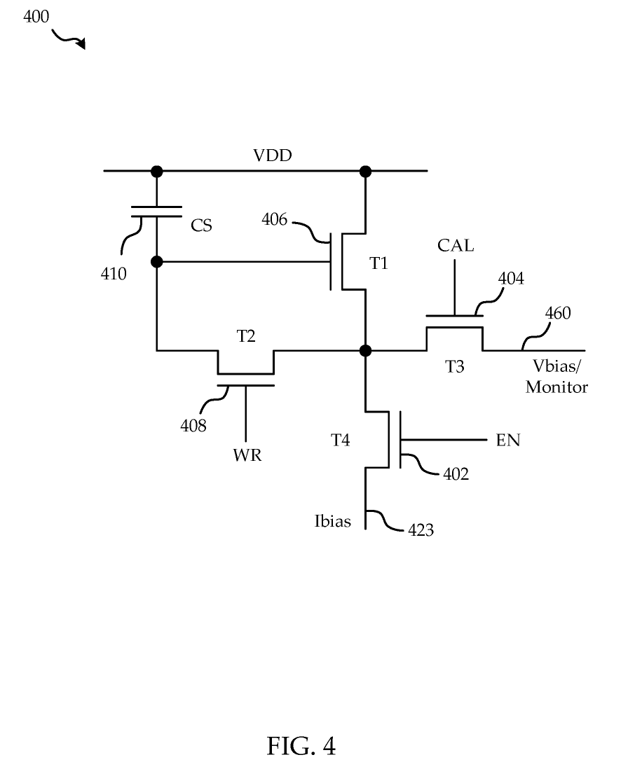

Referring to FIG. 4, the structure of a current source 400 circuit according to an embodiment will now be described. The current source 400 corresponds, for example, to a single current biasing element 155a, 155b of the display system 150 depicted in FIG. 1 which provides a bias current Ibias over current bias lines 123a, 123b to a CBVP pixel 110a, 110b. As is described in more detail below, the connections and manner of integration of current source 400 into the display system 150 is slightly different from that depicted in FIG. 1 for a current sink 200. The current source 400 depicted in FIG. 4 is based on PMOS transistors. It should be understood that variations of this current source and its functioning are contemplated and include different types of transistors (PMOS, NMOS, or CMOS) and different semiconductor materials (e.g., LTPS, Metal Oxide, etc.).

The current source 400 includes a first switch transistor 402 (T4) controlled by an enable signal EN coupled to its gate terminal, and being coupled via one of a source and drain terminal of the first transistor switch 402 to a current bias line 423 (Ibias) corresponding to, for example, a current bias line 123a of FIG. 1. A gate terminal of a current drive transistor 406 (T1) is coupled to a first terminal of a storage capacitance 410, while a first of the source and drain terminals of the current drive transistor 406 is coupled to the other of the source and drain terminals of the first switch transistor 402, and a second of the source and drain terminals of the current drive transistor 406 is coupled to a second terminal of the storage capacitance 410. The second terminal of the storage capacitance 410 is coupled to VDD. A gate terminal of a second switch transistor 408 (T2) is coupled to a write signal line (WR), while one of its source and drain terminals is coupled to the first terminal of the storage capacitance 410 and the other of its source and drain terminals is coupled to the first of the source and drain terminals of the current driving transistor 406. A gate terminal of a third switch transistor 404 (T3) is coupled to a calibration control line (CAL), while one of its source and drain terminals is coupled to a voltage bias monitor line 460, corresponding, for example, to voltage bias or data lines 122a, 122b depicted in FIG. 1. The other of the source and drain terminals of the third switch transistor 404 is coupled to the first of the source and drain terminals of the current drive transistor 406.

In the embodiment depicted in FIG. 4, the current source is not coupled to a reference monitor line 160 such as that depicted in FIG. 1. Instead of the current source 400 being programmed with Vbias and a reference voltage as in the case of the current sink 200, the storage capacitance 410 of the current source 400 is programmed to a defined value using the voltage bias signal Vbias provided over the voltage bias or data line 122a and VDD. In this embodiment the data lines 122a, 122b serve as monitor lines as and when needed.

Referring once again to FIG. 3, an example of a timing of a current control cycle 300 for programming and calibrating the current source 400 depicted in FIG. 4 will now be described. The timing of the current control cycle 300 for programming the current source 400 of FIG. 4 is the same as that for the current sink 200 of FIG. 2.

The complete control cycle 300 occurs typically once per frame and includes four smaller cycles, a disconnect cycle 302, a programming cycle 304, a calibration cycle 306, and a settling cycle 308. During the disconnect cycle 302, the current source 400 ceases to provide biasing current Ibias to the current bias line 423 in response to the EN signal going high and the first transistor switch 402 turning off. By virtue of the CAL and WR signals being high, both the second and third switch transistors 408, 404 remain off. The duration of the disconnect cycle 402 also provides a settling time for the current source 400 circuit. The EN signal remains high throughout the entire control cycle 300, only going low once the current source 400 circuit has been programmed, calibrated, and settled and is ready to provide the bias current over the current bias line 423. Once the current source 400 has settled after the disconnect cycle 302 has completed, the programming cycle 304 begins with the WR signal going low turning on the second switch transistor 408 and with the CAL signal going low turning on the third switch transistor 404. During the programming cycle 304 therefore, the third switch transistor 404 and the second switch transistor 408 connects the voltage bias monitor line 460 over which there is transmitted a known Vbias signal to the first terminal of the storage capacitance 410. As a result, since the second terminal of the storage capacitance 410 is coupled top VDD, the storage capacitance 410 is charged to a defined value. This value is roughly that which is anticipated as necessary to control the current driving transistor 406 to deliver the appropriate current biasing Ibias taking into account optional calibration described below.

After the programming cycle 304 and during the calibration cycle 306, the circuit is reconfigured to discharge some of the voltage (charge) of the storage capacitance 410 though the current driving transistor 406. The calibration signal CAL goes high, turning off the third switch transistor 404 and disconnecting the first terminal of the storage capacitance 410 from the voltage bias monitor line 460. The amount discharged is a function of the main element of the current source 400, namely the current driving transistor 406 or its related components. For example, if the current driving transistor 406 is “strong”, the discharge occurs relatively quickly and relatively more charge is discharged from the storage capacitance 410 through the current driving transistor 406 during the fixed duration of the calibration cycle 306. On the other hand, if the current driving transistor 406 is “weak,” the discharge occurs relatively slowly and relatively less charge is discharged from the storage capacitance 410 through the current driving transistor 406 during the fixed duration of the calibration cycle 306. As a result, the voltage (charge) stored in the storage capacitance 410 is reduced comparatively more for relatively strong current driving transistors versus comparatively less for relatively weak current driving transistors thereby providing some compensation for non-uniformity and variations in current driving transistors across the display whether due to variations in fabrication or degradation over time.

After the calibration cycle 306, a settling cycle 308 is performed prior to provision of the biasing current Ibias to the current bias line 423. During the settling cycle, the first and third switch transistors 402, 404 remain off while the WR signal goes high to also turn the second switch transistor 408 off. After completion of the duration of the settling cycle 308, the enable signal EN goes low turning on the first switch transistor 402 and allowing the current driving transistor 406 to source the Ibias current on the current bias line 423 according to the voltage (charge) stored in the storage capacitance 410, which as mentioned above, has a value which has been drained as a function of the current driving transistor 406 in order to provide compensation for the specific characteristics of the current driving transistor 406.

In some embodiments, the calibration cycle 306 is eliminated. In such a case, the compensation manifested as a change in the voltage (charge) stored by the storage capacitance 410 as a function of the characteristics of the current driving transistor 406 is not automatically provided. In such a case, as with the embodiment above in the context of a current sink 200 a form of manual compensation may be utilized in combination with monitoring for the current source 400.

In some embodiments, after a current source 400 has been programmed, and prior to providing the biasing current over the current bias line 423, the current of the current source 400 is measured through the voltage bias monitor line 460 by controlling the CAL signal to go low, turning on the third switch transistor 404.

Once the current of the current source 400 has been measured in response to known programming of the current source 400 and possibly after a number of various current measurements in response to various programming values have been measured and stored in memory 106, the controller 102 and memory 106 (possibly in cooperation with other components of the display system 150) adjusts the voltage Vbias used to program the current source 400 to compensate for the deviations from the expected or desired current sourcing exhibited by the current source 400. This monitoring and compensation, need not be performed every frame and can be performed in a periodic manner over the lifetime of the display to correct for degradation of the current source 400.

Although the current sink 200 of FIG. 2 and the current source 400 of FIG. 4 have each been depicted as possessing a single current driving transistor 206, 406 it should be understood that each may comprise a cascaded transistor structure for providing the same functionality as shown and described in association with FIG. 2 and FIG. 4.

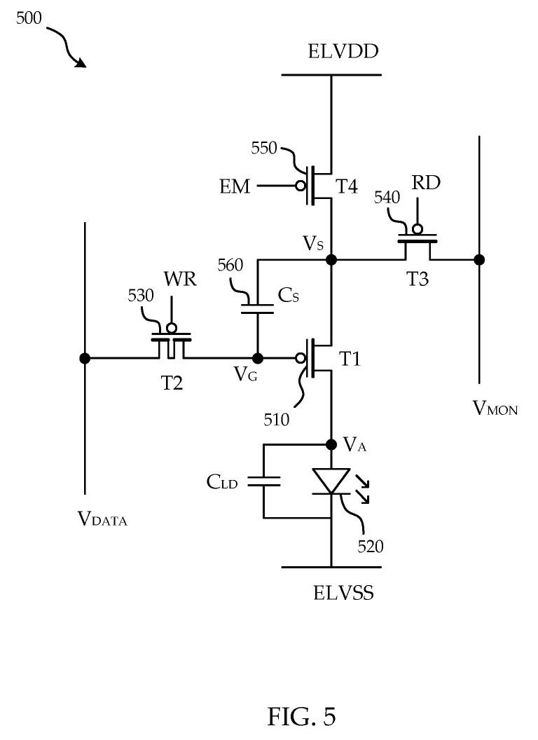

With reference to FIG. 5, the structure of a four transistor, single capacitor (4T1C) pixel circuit 500 according to an embodiment will now be described. The 4T1C pixel circuit 500 corresponds, for example, to a single pixel 110a of the display system 150 depicted in FIG. 1 which in some embodiments is not necessarily a current biased pixel. The 4T1C pixel circuit 500 depicted in FIG. 5 is based on NMOS transistors. It should be understood that variations of this pixel and its functioning are contemplated and include different types of transistors (PMOS, NMOS, or CMOS) and different semiconductor materials (e.g. LTPS, Metal Oxide, etc.).

The 4T1C pixel circuit 500 includes a driving transistor 510 (T1), a light emitting device 520, a first switch transistor 530 (T2), a second switch transistor 540 (T3), a third switch transistor 550 (T4), and a storage capacitor 560 (C_{S}). Each of the driving transistor 510, the first switch transistor 530, the second switch transistor 540, and the third switch transistor 550 having first, second, and gate terminals, and each of the light emitting device 520 and the storage capacitor 560 having first and second terminals.

The gate terminal of the driving transistor 510 is coupled to a first terminal of the storage capacitor 560, while the first terminal of the driving transistor 510 is coupled to the second terminal of the storage capacitor 560, and the second terminal of the driving transistor 510 is coupled to the first terminal of the light emitting device 520. The second terminal of the light emitting device 520 is coupled to a first reference potential ELVSS. A capacitance of the light-emitting device 520 is depicted in FIG. 5 as C_{LD}. In some embodiments, the light emitting device 520 is an OLED. The gate terminal of the first switch transistor 530 is coupled to a write signal line (WR), while the first terminal of the first switch transistor 530 is coupled to a data signal line (V_{DATA}), and the second terminal of the first switch transistor 530 is coupled to the gate terminal of the driving transistor 510. A node common to the gate terminal of the driving transistor 510 and the storage capacitor 560 as well as the first switch transistor 530 is labelled by its voltage V_{G} in the figure. The gate terminal of the second switch transistor 540 is coupled to a read signal line (RD), while the first terminal of the second switch transistor 540 is coupled to a monitor signal line (V_{MON}), and the second terminal of the second switch transistor 540 is coupled to the second terminal of the storage capacitor 560. The gate terminal of the third switch transistor 550 is coupled to an emission signal line (EM), while the first terminal of the third switch transistor 550 is coupled to a second reference potential ELVDD, and the second terminal of the third switch transistor 550 is coupled to the second terminal of the storage capacitor 560. A node common to the second terminal of the storage capacitor 560, the driving transistor 510, the second switch transistor 540, and the third switch transistor 550 is labelled by its voltage Vs in the figure.

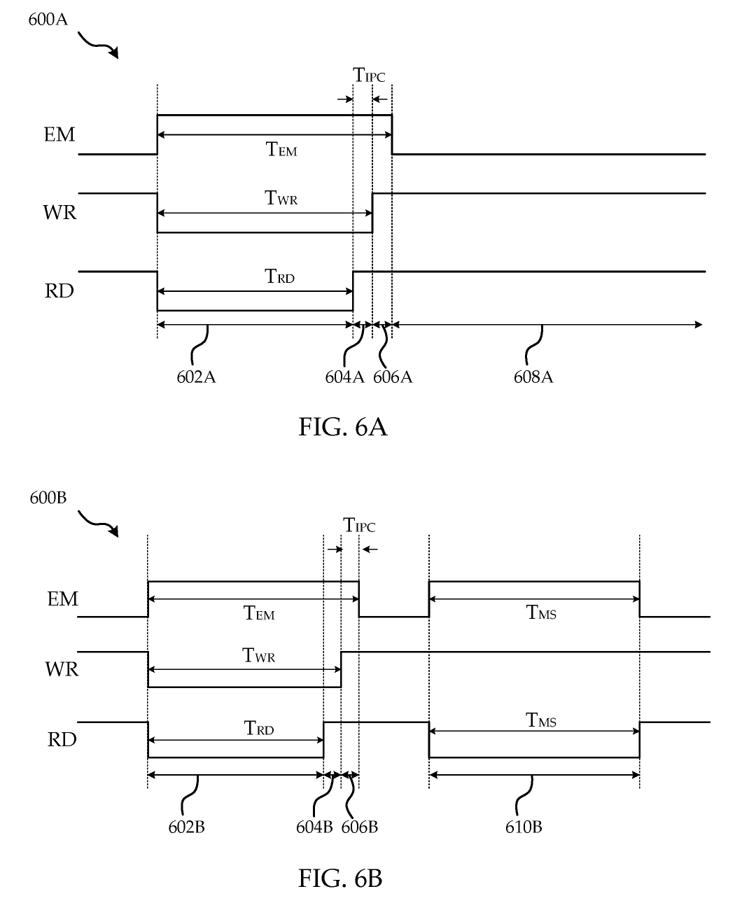

With reference also to FIG. 6A, an example of a display timing 600A for the 4T1C pixel circuit 500 depicted in FIG. 5 will now be described. The complete display timing 600A occurs typically once per frame and includes a programming cycle 602A, a calibration cycle 604A, a settling cycle 606A, and an emission cycle 608A. During the programming cycle 602A over a period T_{RD}, the read signal (RD) and write signal (WR) are held low while the emission (EM) signal is held high. The emission signal (EM) is held high throughout the programming, calibration, and settling cycles 602A 604A 606A to ensure the third switch transistor 550 remains off during those cycles (T_{EM}).

During the programming cycle 602A the first switch transistor 530 and the second switch transistor 540 are both on. The voltage of the storage capacitor 560 and therefore the voltage V_{SG} of the driving transistor 510 is charged to a value of V_{MON}−V_{DATA} where V_{MON} is a voltage of the monitor line and V_{DATA} is a voltage of the data line. These voltages are set in accordance with a desired programming voltage for causing the pixel 500 to emit light at a desired luminance according to image data.

At the beginning of the calibration cycle 604A, the read line (RD) goes high to turn off the second switch transistor 540 to discharge some of the voltage (charge) of the storage capacitor 560 through the driving transistor 510. The amount discharged is a function of the characteristics of the driving transistor 510. For example, if the driving transistor 510 is “strong”, the discharge occurs relatively quickly and relatively more charge is discharged from the storage capacitor 560 through the driving transistor 510 during the fixed duration T_{IPC} of the calibration cycle 604A. On the other hand, if the driving transistor 510 is “weak”, the discharge occurs relatively slowly and relatively less charge is discharged from the storage capacitor 560 through the driving transistor 510 during the calibration cycle 604A. As a result, the voltage (charge) stored in the storage capacitor 560 is reduced comparatively more for relatively strong driving transistors versus comparatively less for relatively weak driving transistors, thereby providing some compensation for non-uniformity and variations in the driving transistors across the display whether due to variations in fabrication or variations in degradation over time.

After the calibration cycle 604A, a settling cycle 606A is performed prior to the emission. During the settling cycle 606A the second and third switch transistors 540, 550 remain off, while the write signal (WR) goes high to also turn off the first switch transistor 530. After completion of the duration of the settling cycle 606A at the start of the emission cycle 608A, the emission signal (EM) goes low turning on the third switch transistor 550 allowing current to flow through the light emitting device 520 according to the calibrated stored voltage on the storage capacitor 560.

With reference also to FIG. 6B, an example of a measurement timing 600B for the 4T1C pixel circuit 500 depicted in FIG. 5 will now be described. The complete measurement timing 600B occurs typically in the same time period as a display frame and includes a programming cycle 602B, a calibration cycle 604B, a settling cycle 606B, and a measurement cycle 610B. The programming cycle 602B, calibration cycle 604B, settling cycle 606B, are performed substantially the same as described above in connection with FIG. 6A, however, a number of the voltages set for V_{DATA}, V_{MON}, and stored on the storage capacitor 560 are determined with the goal of measuring the pixel circuit 500 instead of displaying any particular luminance according to image data.

Once the programming cycle 602B, calibration cycle 604B, and settling cycle 606B are completed, a measuring cycle 610B having duration T_{MS} commences. At the beginning of the measuring cycle 610B, the emission signal (EM) goes high turning off the third switch transistor 550, while the read signal (RD) goes low turning on the second switch transistor 540 to provide read access to the monitor line.

For measurement of the driving transistor 510, the programming voltage V_{SG} for the driving transistor 510 is set to the desired level through the programming 602B, and calibration 604B cycles, and then during the duration T_{M}S of the measurement cycle 610B the current/charge is observed on the monitor line V_{MON}. The voltage V_{MON} on the monitor line is kept at a high enough level in order to operate the driving transistor 510 in saturation mode for measurement of the driving transistor 510.

For measurement of the light emitting device 520, the programming voltage V_{SG} for the driving transistor 510 is set to the highest possible voltage available on the data line V_{DATA}, for example a value corresponding to peak-white gray-scale, through the programming 602B, and calibration 604B cycles, in order to operate the driving transistor 510 in the triode region (switch mode). In this condition, during the duration T_{MS} of the measurement cycle 610B the voltage/current of the light emitting device 520 can be directly modulated/measured through the monitor line.

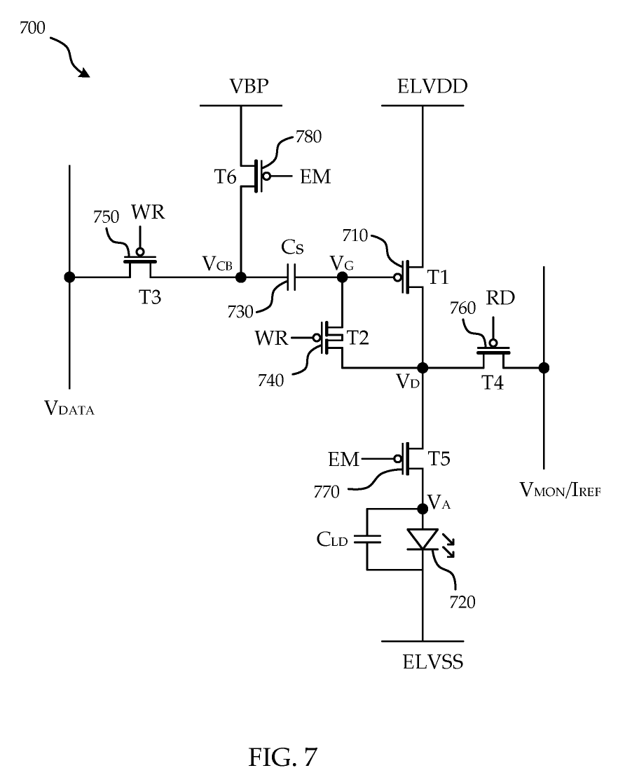

With reference to FIG. 7, the structure of a six transistor, single capacitor (6T1C) pixel circuit 700 according to an embodiment will now be described. The 6T1C pixel circuit 700 corresponds, for example, to a single pixel 110a of the display system 150 depicted in FIG. 1 which in some embodiments is not necessarily a current biased pixel. The 6T1C pixel circuit 700 depicted in FIG. 7 is based on NMOS transistors. It should be understood that variations of this pixel and its functioning are contemplated and include different types of transistors (PMOS, NMOS, or CMOS) and different semiconductor materials (e.g. LTPS, Metal Oxide, etc.).

The 6T1C pixel circuit 700 includes a driving transistor 710 (T1), a light emitting device 720, a storage capacitor 730 (C_{S}), a first switch transistor 740 (T2), a second switch transistor 750 (T3), a third switch transistor 760 (T4), a fourth switch transistor 770 (T5), and a fifth switch transistor 780 (T6). Each of the driving transistor 710, the first switch transistor 740, the second switch transistor 750, the third switch transistor 760, the fourth switch transistor 770, and the fifth switch transistor 780, having first, second, and gate terminals, and each of the light emitting device 720 and the storage capacitor 730 having first and second terminals.

The gate terminal of the driving transistor 710 is coupled to a first terminal of the storage capacitor 730, while the first terminal of the driving transistor 710 is coupled to a first reference potential ELVDD, and the second terminal of the driving transistor 710 is coupled to the first terminal of the third switch transistor 760. The gate terminal of the third switch transistor 760 is coupled to a read signal line (RD) and the second terminal of the third switch transistor 760 is coupled to a monitor/reference current line V_{MON}/I_{REF}. The gate terminal of the fourth switch transistor 770 is coupled to an emission signal line (EM), while the first terminal of the fourth switch transistor 770 is coupled to the first terminal of the third switch transistor 760, and the second terminal of the fourth switch transistor 770 is coupled to the first terminal of the light emitting device 720. A second terminal of the light emitting device 720 is coupled to a second reference potential ELVSS. A capacitance of the light-emitting device 720 is depicted in FIG. 7 as C_{LD}. In some embodiments, the light emitting device 720 is an OLED. The gate terminal of the first switch transistor 740 is coupled to a write signal line (WR), while the first terminal of the first switch transistor 740 is coupled to the first terminal of the storage capacitor 730, and the second terminal of the first switch transistor 740 is coupled to the first terminal of the third switch transistor 760. The gate terminal of the second switch transistor 750 is coupled to the write signal line (WR), while the first terminal of the second switch transistor 750 is coupled to a data signal line (V_{DATA}), and the second terminal of the second switch transistor 750 is coupled to the second terminal of the storage capacitor 730. A node common to the gate terminal of the driving transistor 710 and the storage capacitor 730 as well as the first switch transistor 740 is labelled by its voltage V_{G} in the figure. The gate terminal of the fifth switch transistor 780 is coupled to the emission signal line (EM), while the first terminal of the fifth switch transistor 780 is coupled to reference potential VBP, and the second terminal of the fifth switch transistor 780 is coupled to the second terminal of the storage capacitor 730. A node common to the second terminal of the storage capacitor 730, the second switch transistor 750, and the fifth switch transistor 780 is labelled by its voltage V_{CB} in FIG. 7.

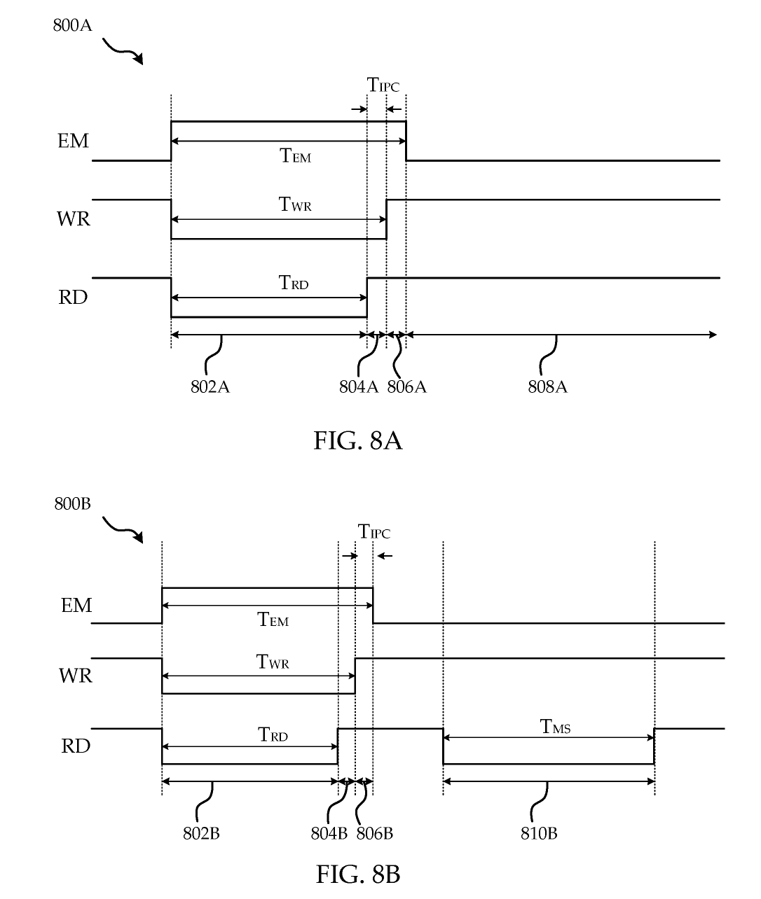

With reference also to FIG. 8A, an example of a display timing 800A for the 6T1C pixel circuit 700 depicted in FIG. 7 will now be described. The complete display timing 800A occurs typically once per frame and includes a programming cycle 802A, a calibration cycle 804A, a settling cycle 806A, and an emission cycle 808A. During the programming cycle 802A over a period T_{RD}, the read signal (RD) and write signal (WR) are held low while the emission (EM) signal is held high. The emission signal (EM) is held high throughout the programming, calibration, and settling cycles 802A 804A 806A to ensure the fourth switch transistor 770 and the fifth switch transistor 780 remain off during those cycles (T_{EM}).

During the programming cycle 802A the first switch transistor 740, the second switch transistor 750, and the third switch transistor 760 are all on. The voltage of the storage capacitor 730 V_{CS} is charged to a value of V_{CB}−V_{G}=V_{DATA}−(V_{DD}−V_{SG}(T1))≈V_{DATA}−V_{DD}+Vₜₕ(T1), where V_{DATA} is a voltage on the data line, V_{DD} is the voltage of the first reference potential (also referred to as ELVDD), V_{SG}(T1) the voltage across the gate terminal and the first terminal of the driving transistor 710, and Vₜₕ(T1) is a threshold voltage of the driving transistor 710. Here V_{DATA} is set taking into account a desired programming voltage for causing the pixel 700 to emit light at a desired luminance according to image data.

At the beginning of the calibration cycle 804A, the read line (RD) goes high to turn off the third switch transistor 760 to discharge some of the voltage (charge) of the storage capacitor 730 through the driving transistor 710. The amount discharged is a function of the characteristics of the driving transistor 710. For example, if the driving transistor 710 is “strong”, the discharge occurs relatively quickly and relatively more charge is discharged from the storage capacitor 730 through the driving transistor 710 during the fixed duration T_{IPC} of the calibration cycle 804A. On the other hand, if the driving transistor 710 is “weak,” the discharge occurs relatively slowly and relatively less charge is discharged from the storage capacitor 730 through the driving transistor 710 during the calibration cycle 804A. As a result, the voltage (charge) stored in the storage capacitor 730 is reduced comparatively more for relatively strong driving transistors versus comparatively less for relatively weak driving transistors, thereby providing some compensation for non-uniformity and variations in the driving transistors across the display whether due to variations in fabrication or variations in degradation over time.

After the calibration cycle 804A, a settling cycle 806A is performed prior to the emission cycle 808A. During the settling cycle 806A the third, fourth, and fifth switch transistors 760, 770, and 780 remain off, while the write signal (WR) goes high to also turn off the first and second switch transistors 740, 750. After completion of the duration of the settling cycle 806A at the start of the emission cycle 808A, the emission signal (EM) goes low turning on the fourth and fifth switch transistors 770, 780. This causes the driving transistor 710 to be driven with a voltage V_{SG}=V_{DD}−V_{G}=V_{DD}−(VBP−V_{CS})=V_{DD}−VBP+V_{DATA}−V_{DD}+Vₜₕ(T1)=V_{DATA}+Vₜₕ(T1)−VBP. This allows current to flow through the light emitting device 720 according to the calibrated stored voltage on the storage capacitor 730, and which is also a function of the threshold voltage Vₜₕ(T1) of the driving transistor 710 and which is independent of V_{DD}.

With reference also to FIG. 8B, an example of a measurement timing 800B for the 6T1C pixel circuit 700 depicted in FIG. 7 will now be described. The complete measurement timing 800B occurs typically in the same time period as a display frame and includes a programming cycle 802B, a calibration cycle 804B, a settling cycle 806B, and a measurement cycle 810B. The programming cycle 802B, calibration cycle 804B, settling cycle 806B, are performed substantially the same as described above in connection with FIG. 8A, however, a number of voltages set for V_{DATA}, V_{MON}, VBP, and stored on the storage capacitor 730 are determined with the goal of measuring the pixel circuit 700 instead of displaying any particular luminance according to image data.

Once the programming cycle 802B, calibration cycle 804B, and settling cycle 806B are completed, a measuring cycle 810B having duration T_{MS} commences. At the beginning of the measuring cycle 810B, the read signal (RD) goes low turning on the third switch transistor 760 to provide read access to the monitor line. The emission signal (EM) is kept low, and hence the fourth and fifth switch transistors 770, 780 are kept on during the entire duration T_{MS} of the measurement.

For measurement of the driving transistor 710, the programming voltage V_{SG} for the driving transistor 710 is set to the desired level through the programming 802B, and calibration 804B, settling 806B, and emission 808B cycles, and then during the duration T_{MS} of the measurement cycle 810B the current/charge is observed on the monitor line V_{MON}. The voltage of the second reference potential (ELVSS) is raised to a high enough level (for example to ELVDD) in order to avoid interference from the light emitting device 720.

For measurement of the light emitting device 720, the programming voltage V_{SG} for the driving transistor 710 is set to the lowest possible voltage available on the data line V_{DATA}, for example a value corresponding to black-level gray-scale, through the programming 802B, calibration 804B, settling 806B and emission 808B cycles, in order to avoid interfering with the current of the light emitting device 720.

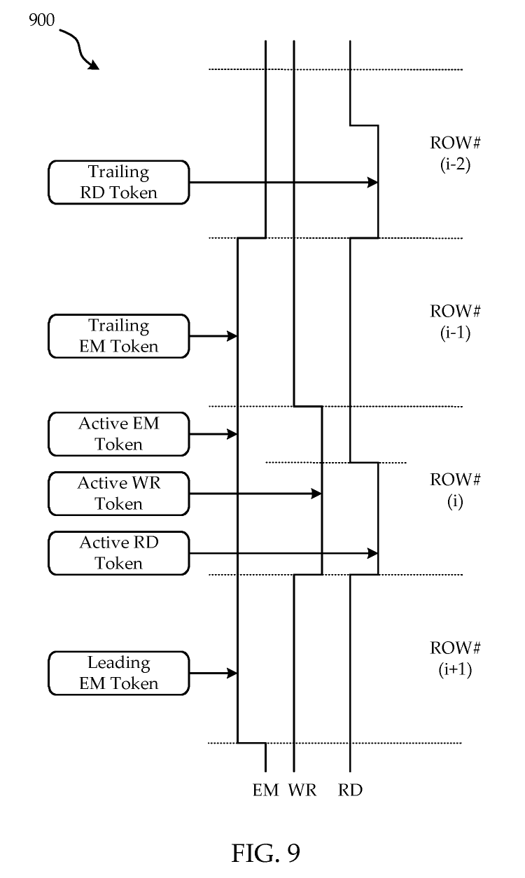

With reference to FIG. 9, a diagram for improved timing 900 for driving rows of pixels, such as the 4T1C and 6T1C pixels described herein, similar to the timing cycles illustrated herein, will now be described.

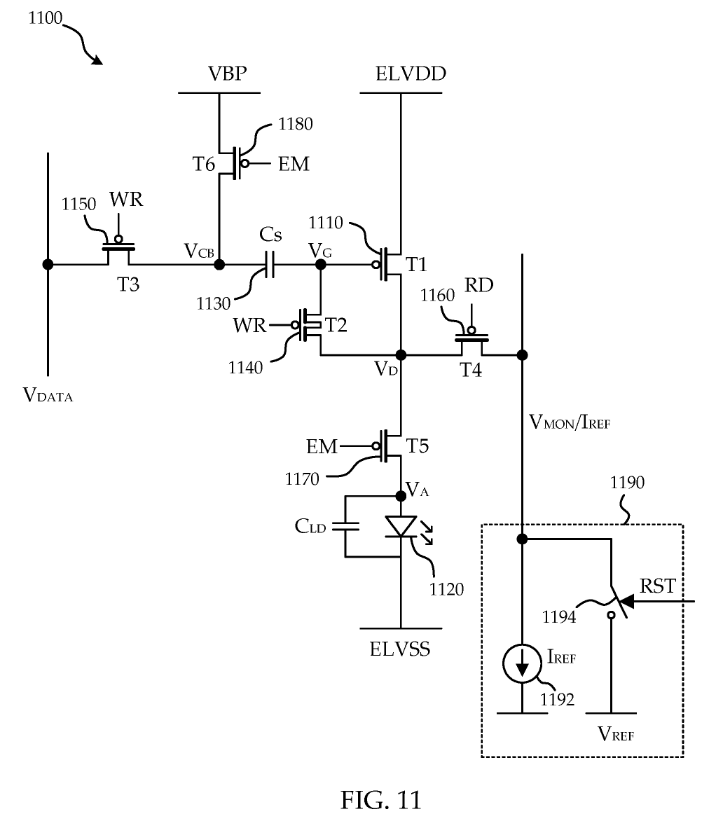

For illustrative purposes the improved timing 900 is shown in relation to its application to four consecutive rows, Row #(i−2), Row #(i−1), Row #(i), and Row #(i+1). The high emission signal EM spans three rows, Row #(i+1), Row #(i), Row #(i−1), the leading EM token spanning row Row #(i+1) is followed by the active EM token spanning Row #(i) which is followed by the trailing EM token spanning Row #(i−1). These are used to ensure steady-state condition for all pixels on a row during the active programming time of Row#(i). The start of an active RD token on Row#(i) trails the leading EM token but is in line with an Active WR token, and corresponds to the simultaneous going low of the RD and WR signals at the start of the programming cycle described in association with other timing diagrams herein. The Active RD token ends prior to the end of the Active WR token for Row#(i), which corresponds to the calibration cycle allowing for partial discharge of the storage capacitor through the driving transistor. A trailing RD token Row#(i−2) is asserted with a gap after the active RD token (and once EN is low and the pixel is just beginning to emit light) in order to reset the anode of the light-emitting device (OLED) and drain of the driving transistor to a low reference voltage available on the monitor line. This further “reset cycle” via the monitor line is particularly useful in embodiments such as the 6T1C pixels 700, 1100 of FIG. 7 and FIG. 11.

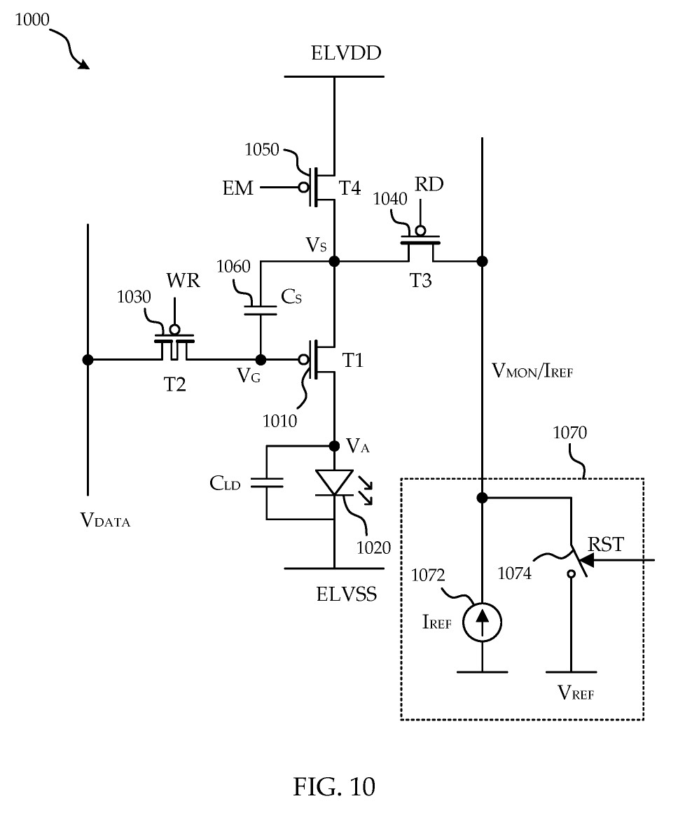

With reference to FIG. 10, the structure of a four transistor, single capacitor (4T1C) pixel circuit 1000 operated in current mode according to an embodiment will now be described. The 4T1C pixel circuit 1000 corresponds, for example, to a single pixel 110a of the display system 150 depicted in FIG. 1. The embodiment depicted in FIG. 10 is a current biased pixel. An associated biasing circuit 1070 for biasing the 4T1C pixel circuit 1000 is illustrated. The biasing circuit 1070 is coupled to the 4T1C pixel circuit 1000 via the monitoring/current bias line (V_{MON}/I_{REF}). The 4T1C pixel circuit 1000 depicted in FIG. 10 is based on NMOS transistors. It should be understood that variations of this pixel and its functioning are contemplated and include different types of transistors (PMOS, NMOS, or CMOS) and different semiconductor materials (e.g., LTPS, Metal Oxide, etc.).

The 4T1C pixel circuit 1000 is structured substantially the same as the 4T1C pixel circuit 500 illustrated in FIG. 5. The 4T1C pixel circuit 1000 includes a driving transistor 1010 (T1), a light emitting device 1020, a first switch transistor 1030 (T2), a second switch transistor 1040 (T3), a third switch transistor 1050 (T4), and a storage capacitor 1060 (C_{S}). Each of the driving transistor 1010, the first switch transistor 1030, the second switch transistor 1040, and the third switch transistor 1050 having first, second, and gate terminals, and each of the light emitting device 1020 and the storage capacitor 1060 having first and second terminals.

The gate terminal of the driving transistor 1010 is coupled to a first terminal of the storage capacitor 1060, while the first terminal of the driving transistor 1010 is coupled to the second terminal of the storage capacitor 1060, and the second terminal of the driving transistor 1010 is coupled to the first terminal of the light emitting device 1020. The second terminal of the light emitting device 1020 is coupled to a first reference potential ELVSS. A capacitance of the light-emitting device 1020 is depicted in FIG. 10 as C_{LD}. In some embodiments, the light emitting device 1020 is an OLED. The gate terminal of the first switch transistor 1030 is coupled to a write signal line (WR), while the first terminal of the first switch transistor 1030 is coupled to a data signal line (V_{DATA}), and the second terminal of the first switch transistor 1030 is coupled to the gate terminal of the driving transistor 1010. A node common to the gate terminal of the driving transistor 1010 and the storage capacitor 1060 as well as the first switch transistor 1030 is labelled by its voltage V_{G} in the figure. The gate terminal of the second switch transistor 1040 is coupled to a read signal line (RD), while the first terminal of the second switch transistor 1040 is coupled to a monitor/reference current line (V_{MON}/I_{REF}), and the second terminal of the second switch transistor 1040 is coupled to the second terminal of the storage capacitor 1060. The gate terminal of the third switch transistor 1050 is coupled to an emission signal line (EM), while the first terminal of the third switch transistor 1050 is coupled to a second reference potential ELVDD, and the second terminal of the third switch transistor 1050 is coupled to the second terminal of the storage capacitor 1060. A node common to the second terminal of the storage capacitor 1060, the driving transistor 1010, the second switch transistor 1040, and the third switch transistor 1050 is labelled by its voltage Vs in the figure.

Coupled to the monitor/reference current line is a biasing circuit 1070, including a current source 1072 providing reference current I_{REF} for current biasing of the pixel, as well as a reference voltage V_{REF} which is selectively coupled to the monitor/reference current line via a switch 1074 which is controlled by a reset (RST) signal.

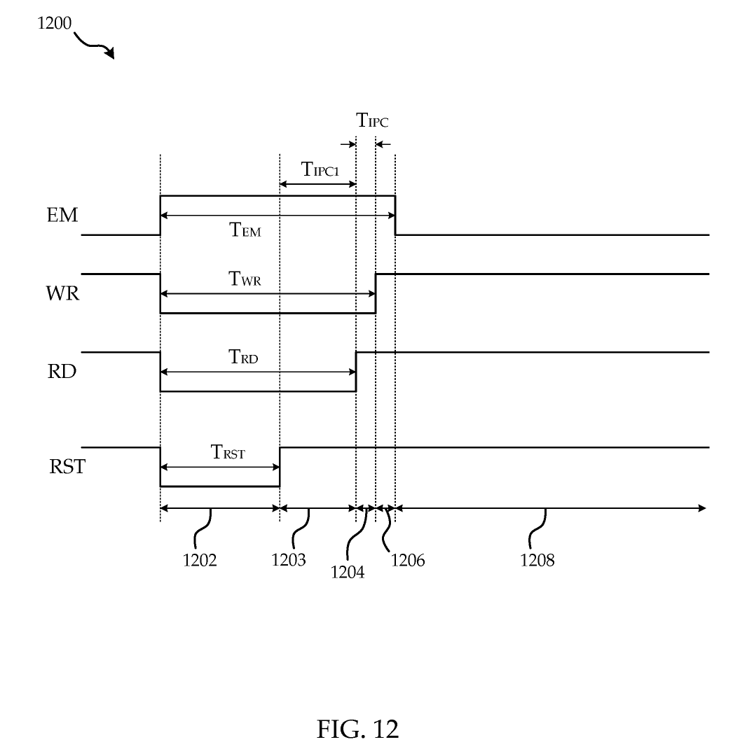

The functioning of 4T1C pixel 1000 is substantially similar to that described hereinabove with respect to the 4T1C pixel 500 of FIG. 5. The 4T1C pixel 1000 of FIG. 10, however, operates in current mode in cooperation with biasing circuit 1070, a timing of which operation is described in connection with FIG. 12 hereinbelow.

With reference to FIG. 11, the structure of a six transistor, single capacitor (6T1C) pixel circuit 1100 operated in current mode according to an embodiment will now be described. The 6T1C pixel circuit 1100 corresponds, for example, to a single pixel 110a of the display system 150 depicted in FIG. 1. The embodiment depicted in FIG. 11 is a current biased pixel. An associated biasing circuit 1190 for biasing the 6T1C pixel circuit 1100 is illustrated. The biasing circuit 1190 is coupled to the 6T1C pixel circuit 1100 via the monitoring/current bias line (V_{MON}/I_{REF}). The 6T1C pixel circuit 1100 depicted in FIG. 11 is based on NMOS transistors. It should be understood that variations of this pixel and its functioning are contemplated and include different types of transistors (PMOS, NMOS, or CMOS) and different semiconductor materials (e.g. LTPS, Metal Oxide, etc.).

The 6T1C pixel circuit 1100 is structured substantially the same as the 6T1C pixel circuit 700 illustrated in FIG. 7. The 6T1C pixel circuit 1100 includes a driving transistor 1110 (T1), a light emitting device 1120, a storage capacitor 1130 (C_{S}), a first switch transistor 1140 (T2), a second switch transistor 1150 (T3), a third switch transistor 1160 (T4), a fourth switch transistor 1170 (T5), and a fifth switch transistor 1180 (T6). Each of the driving transistor 1110, the first switch transistor 1140, the second switch transistor 1150, the third switch transistor 1160, the fourth switch transistor 1170, and the fifth switch transistor 1180, having first, second, and gate terminals, and each of the light emitting device 1120 and the storage capacitor 1130 having first and second terminals.

The gate terminal of the driving transistor 1110 is coupled to a first terminal of the storage capacitor 1130, while the first terminal of the driving transistor 1110 is coupled to a first reference potential ELVDD, and the second terminal of the driving transistor 1110 is coupled to the first terminal of the third switch transistor 1160. The gate terminal of the third switch transistor 1160 is coupled to a read signal line (RD) and the second terminal of the third switch transistor 1160 is coupled to a monitor/reference current line V_{MON}/I_{REF}. The gate terminal of the fourth switch transistor 1170 is coupled to an emission signal line (EM), while the first terminal of the fourth switch transistor 1170 is coupled to the first terminal of the third switch transistor 1160, and the second terminal of the fourth switch transistor 1170 is coupled to the first terminal of the light emitting device 1120. A second terminal of the light emitting device 1120 is coupled to a second reference potential ELVSS. A capacitance of the light-emitting device 1120 is depicted in FIG. 11 as C_{LD}. In some embodiments, the light emitting device 1120 is an OLED. The gate terminal of the first switch transistor 1140 is coupled to a write signal line (WR), while the first terminal of the first switch transistor 1140 is coupled to the first terminal of the storage capacitor 1130, and the second terminal of the first switch transistor 1140 is coupled to the first terminal of the third switch transistor 1160. The gate terminal of the second switch transistor 1150 is coupled to the write signal line (WR), while the first terminal of the second switch transistor 1150 is coupled to a data signal line (V_{DATA}), and the second terminal of the second switch transistor 1150 is coupled to the second terminal of the storage capacitor 1130. A node common to the gate terminal of the driving transistor 1110 and the storage capacitor 1130 as well as the first switch transistor 1140 is labelled by its voltage V_{G} in the figure. The gate terminal of the fifth switch transistor 1180 is coupled to the emission signal line (EM), while the first terminal of the fifth switch transistor 1180 is coupled to VBP, and the second terminal of the fifth switch transistor 1180 is coupled to the second terminal of the storage capacitor 1130. A node common to the second terminal of the storage capacitor 1130, the second switch transistor 1150, and the fifth switch transistor 1180 is labelled by its voltage V_{CB} in FIG. 11.

Coupled to the monitor/reference current line is a biasing circuit 1190, including a current sink 1192 providing reference current I_{REF} for current biasing of the pixel, as well as a reference voltage V_{REF} which is selectively coupled to the monitor/reference current line via a switch 1194 which is controlled by a reset (RST) signal.

With reference also to FIG. 12, an example of a display timing 1200 for the 4T1C pixel circuit 1000 depicted in FIG. 10 and the 6T1C pixel circuit 1100 depicted in FIG. 11 will now be described. The complete display timing 1200 occurs typically once per frame and includes first and second programming cycles 1202, 1203, a calibration cycle 1204, a settling cycle 1206, and an emission cycle 1208. During the first programming cycle 1202 over a period T_{RST} the reset (RST) signal, read signal (RD), and write signal (WR) are held low while the emission (EM) signal is held high. The emission signal (EM) is held high throughout the programming, calibration, and settling cycles 1202, 1203, 1204, 1206 the entire duration thereof T_{EM}. During the second programming, calibration, settling, and emission cycles 1203, 1204, 1206, 1208, the 4T1C and 6T1C pixel circuits 1000, 1100 function as described above in connection with FIG. 5 and FIG. 7 with the exception that they are current biased.

For the 4T1C pixel circuit 1000, during the first programming cycle 1202 a reference voltage V_{REF} is coupled through the switch 1074 and the second switch transistor 1040 to the node common to the storage capacitor 1060, the driving transistor 1010, and the third switch transistor 1050, to reset voltage Vs to V_{REF}. The voltage of the storage capacitor 1060 and therefore the voltage V_{SG} of the driving transistor 1010 is charged to a value of V_{REF}−V_{DATA} where V_{REF} is a voltage of the monitor line and V_{DATA} is a voltage of the data line. These voltages are set in accordance with a desired programming voltage for causing the pixel 1000 to emit light at a desired luminance according to image data. At the end of the first programming cycle 1202, the rest signal goes high turning off the switch 1074 and disconnecting the monitor/reference current line from the reference voltage V_{REF}. After the first programming cycle the read signal stays high allowing the reference current I_{REF} to continue to bias the pixel 1000 during the second programming cycle 1203. To achieve a desirable level of compensation for both threshold and mobility variations, each pixel of a row is driven with a reference current I_{REF} during programming of the pixel, including during both the first and second programming cycles 1202, 1203.

For the 6T1C pixel circuit 1100, during the first programming cycle 1202 a reference voltage V_{REF} is coupled through the switch 1194 and the third switch transistor 1160 to the node common to the first switch transistor 1140, the driving transistor 1110, and the third switch transistor 1160, and the fourth switch transistor 1170, to reset voltage V_{D} to V_{REF}, and the first switch transistor 1140, the second switch transistor 1150, and the third switch transistor 1160 are all on. The voltage of the storage capacitor 1130 V_{CS} is charged to a value of V_{CB}−V_{G}=V_{DATA}−(V_{DD}−V_{SG}(T1)) V_{DATA}−V_{DD}+Vₜₕ(T1), where V_{DATA} is a voltage on the data line, V_{DD} is the voltage of the first reference potential (also referred to as ELVDD), V_{SG}(T1) the voltage across the gate terminal and the first terminal of the driving transistor 1110, and Vₜₕ(T1) is a threshold voltage of the driving transistor 1110. Here V_{DATA} set taking into account a desired programming voltage for causing the pixel 1100 to emit light at a desired luminance according to image data.

At the end of the first programming cycle 1202, the rest (RST) signal goes high turning off the switch 1194 and disconnecting the monitor/reference current line from the reference voltage V_{REF}. After the first programming cycle 1202 the read signal stays high allowing the reference current source 1192 I_{REF} to continue to bias the pixel 1000 during the second programming cycle 1203. To achieve a desirable level of compensation for both threshold and mobility variations, each pixel of a row is driven with the reference current I_{REF} during programming of the pixel, including during both the first and second programming cycles 1202, 1203.

At the beginning of the calibration cycle 1204, the read line (RD) goes high to turn off the third switch transistor 1260 to discharge some of the voltage (charge) of the storage capacitor 1130 through the driving transistor 1110 and to stop current biasing by the bias circuit 1190. The amount discharged is a function of the characteristics of the driving transistor 1110. For example, if the driving transistor 1110 is “strong”, the discharge occurs relatively quickly and relatively more charge is discharged from the storage capacitor 1130 through the driving transistor 1110 during the fixed duration T_{IPC} of the calibration cycle 1204. On the other hand, if the driving transistor 1110 is “weak”, the discharge occurs relatively slowly and relatively less charge is discharged from the storage capacitor 1130 through the driving transistor 1110 during the calibration cycle 1204. As a result, the voltage (charge) stored in the storage capacitor 1130 is reduced comparatively more for relatively strong driving transistors versus comparatively less for relatively weak driving transistors, thereby providing some compensation for non-uniformity and variations in the driving transistors across the display whether due to variations in fabrication or variations in degradation over time.

After the calibration cycle 1204, a settling cycle 1206 is performed prior to the emission cycle 1208. During the settling cycle 1206 the third, fourth, and fifth switch transistors 1160, 1170, and 1180 remain off, while the write signal (WR) goes high to also turn off the first and second switch transistors 1140, 1150. After completion of the duration of the settling cycle 1206 at the start of the emission cycle 1208, the emission signal (EM) goes low turning on the fourth and fifth switch transistors 1170, 1180. This causes the driving transistor 1110 to be driven with a voltage V_{SG}=V_{DD}−V_{G}=V_{DD}−(VBP−V_{CS})=V_{DD}−VBP+V_{DATA}−V_{DD}+Vₜₕ(T1)=V_{DATA}+Vₜₕ(T1)−VBP. This allows current to flow through the light emitting device 1120 according to the calibrated stored voltage on the storage capacitor 1130, and which is also a function of the threshold voltage Vₜₕ(T1) of the driving transistor 1110 and which is independent of V_{DD}.

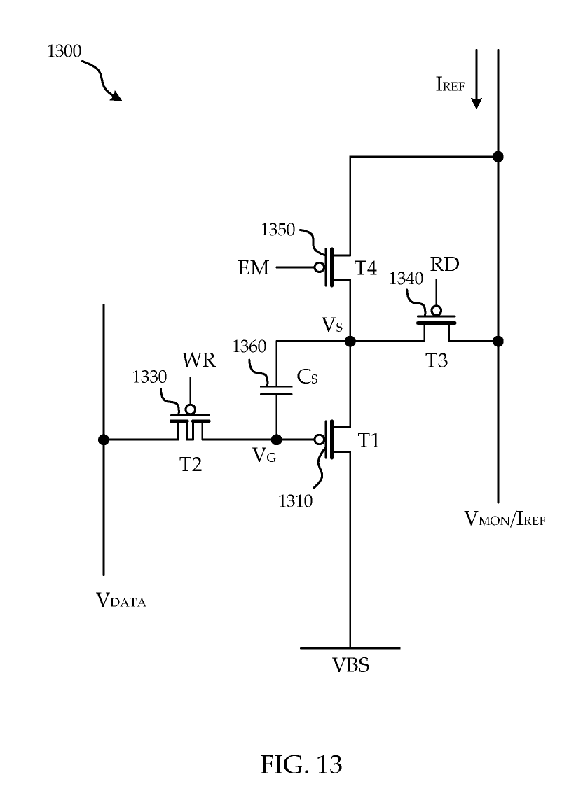

With reference to FIG. 13, the structure of a four transistor, single capacitor (4T1C) reference current sink 1300 according to an embodiment will now be described. The 4T1C reference current sink 1300 corresponds, for example, to a sink 155a of the display system 150 depicted in FIG. 1 or a sink 1192 depicted in FIG. 11. The 4T1C reference current sink 1300 depicted in FIG. 13 is based on NMOS transistors. It should be understood that variations of this sink and its functioning are contemplated and include different types of transistors (PMOS, NMOS, or CMOS) and different semiconductor materials (e.g., LTPS, Metal Oxide, etc.).

The 4T1C reference current sink 1300 includes a driving transistor 1310 (T1), a first switch transistor 1330 (T2), a second switch transistor 1340 (T3), a third switch transistor 1350 (T4), and a storage capacitor 1360 (C_{S}). Each of the driving transistor 1310, the first switch transistor 1330, the second switch transistor 1340, and the third switch transistor 1350 having first, second, and gate terminals, and the storage capacitor 1360 having first and second terminals.

The gate terminal of the driving transistor 1310 is coupled to a first terminal of the storage capacitor 1360, while the first terminal of the driving transistor 1310 is coupled to the second terminal of the storage capacitor 1360, and the second terminal of the driving transistor 1310 is coupled to a reference potential VBS. The gate terminal of the first switch transistor 1330 is coupled to a write signal line (WR), while the first terminal of the first switch transistor 1330 is coupled to a data signal line (V_{DATA}), and the second terminal of the first switch transistor 1330 is coupled to the gate terminal of the driving transistor 1310. A node common to the gate terminal of the driving transistor 1310 and the storage capacitor 1360 as well as the first switch transistor 1330 is labelled by its voltage V_{G} in the figure. The gate terminal of the second switch transistor 1340 is coupled to a read signal line (RD), while the first terminal of the second switch transistor 1340 is coupled to a monitor signal line (V_{MON}), and the second terminal of the second switch transistor 1340 is coupled to the second terminal of the storage capacitor 1360. The gate terminal of the third switch transistor 1350 is coupled to an emission signal line (EM), while the first terminal of the third switch transistor 1350 is coupled to the monitor signal line, and the second terminal of the third switch transistor 1350 is coupled to the second terminal of the storage capacitor 1360. A node common to the second terminal of the storage capacitor 1360, the driving transistor 1310, the second switch transistor 1340, and the third switch transistor 1350 is labelled by its voltage Vs in the figure.

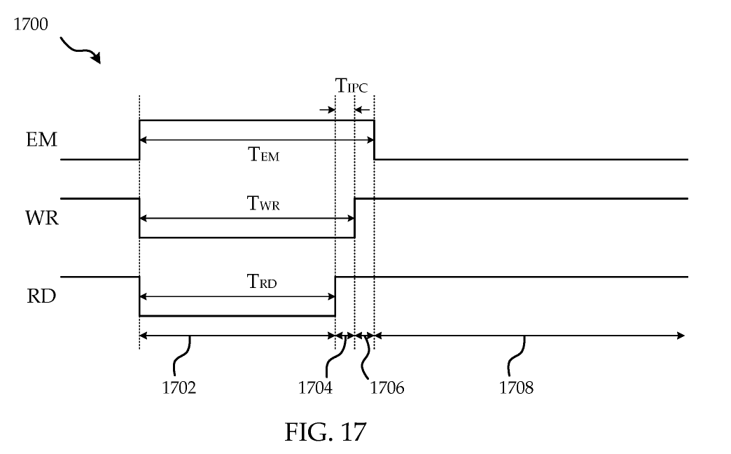

The functioning of the 4T1C reference current sink 1300 will be described in connection with the timing diagram of FIG. 17 discussed hereinbelow.

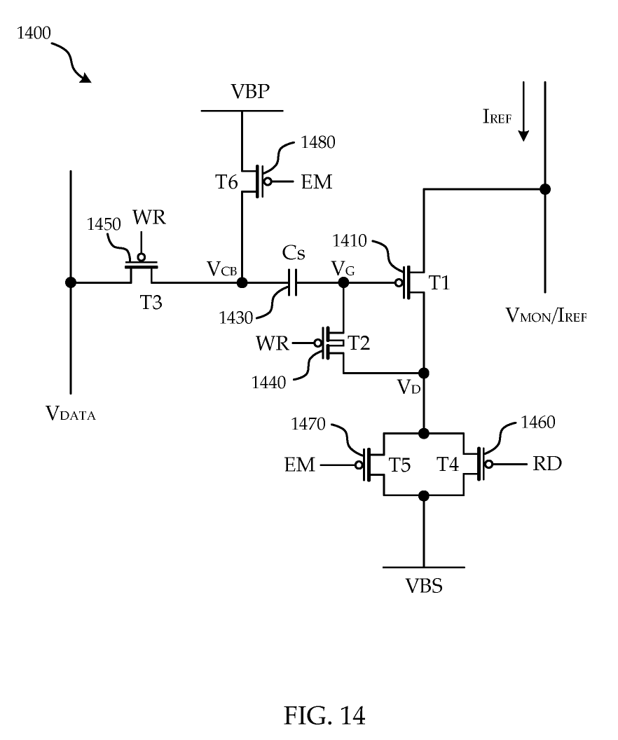

With reference to FIG. 14, the structure of a six transistor, single capacitor (6T1C) reference current sink 1400 according to an embodiment will now be described. The 6T1C reference current sink 1400 corresponds, for example, to a sink 155a of the display system 150 depicted in FIG. 1 or a sink 1192 depicted in FIG. 11. The 6T1C reference current sink 1400 depicted in FIG. 14 is based on NMOS transistors. It should be understood that variations of this sink and its functioning are contemplated and include different types of transistors (PMOS, NMOS, or CMOS) and different semiconductor materials (e.g. LTPS, Metal Oxide, etc.).

The 6T1C reference current sink 1400 includes a driving transistor 1410 (T1), a storage capacitor 1430 (C_{S}), a first switch transistor 1440 (T2), a second switch transistor 1450 (T3), a third switch transistor 1460 (T4), a fourth switch transistor 1470 (T5), and a fifth switch transistor 1480 (T6). Each of the driving transistor 1410, the first switch transistor 1440, the second switch transistor 1450, the third switch transistor 1460, the fourth switch transistor 1470, and the fifth switch transistor 1480, having first, second, and gate terminals, and the storage capacitor 1430 having first and second terminals.

The gate terminal of the driving transistor 1410 is coupled to a first terminal of the storage capacitor 1430, while the first terminal of the driving transistor 1410 is coupled to the monitor/current reference line (V_{MON}/I_{REF}), and the second terminal of the driving transistor 1410 is coupled to the first terminal of the third switch transistor 1460. The gate terminal of the third switch transistor 1460 is coupled to a read signal line (RD) and the second terminal of the third switch transistor 1460 is coupled to VBS. The gate terminal of the fourth switch transistor 1470 is coupled to an emission signal line (EM), while the first terminal of the fourth switch transistor 1470 is coupled to the first terminal of the third switch transistor 1460, and the second terminal of the fourth switch transistor 1470 is coupled to the second terminal of the third switch transistor 1460. The gate terminal of the first switch transistor 1440 is coupled to a write signal line (WR), while the first terminal of the first switch transistor 1440 is coupled to the first terminal of the storage capacitor 1430, and the second terminal of the first switch transistor 1440 is coupled to the first terminal of the third switch transistor 1460. The gate terminal of the second switch transistor 1450 is coupled to the write signal line (WR), while the first terminal of the second switch transistor 1450 is coupled to a data signal line (V_{DATA}), and the second terminal of the second switch transistor 1450 is coupled to the second terminal of the storage capacitor 1430. A node common to the gate terminal of the driving transistor 1410 and the storage capacitor 1430 as well as the first switch transistor 1440 is labelled by its voltage V_{G} in the figure. The gate terminal of the fifth switch transistor 1480 is coupled to the emission signal line (EM), while the first terminal of the fifth switch transistor 1480 is coupled to VBP, and the second terminal of the fifth switch transistor 1480 is coupled to the second terminal of the storage capacitor 1430. A node common to the second terminal of the storage capacitor 1430, the second switch transistor 1450, and the fifth switch transistor 1480 is labelled by its voltage V_{CB} in FIG. 14.

The functioning of the 6T1C reference current sink 1400 will be described in connection with the timing diagram of FIG. 17 discussed hereinbelow.

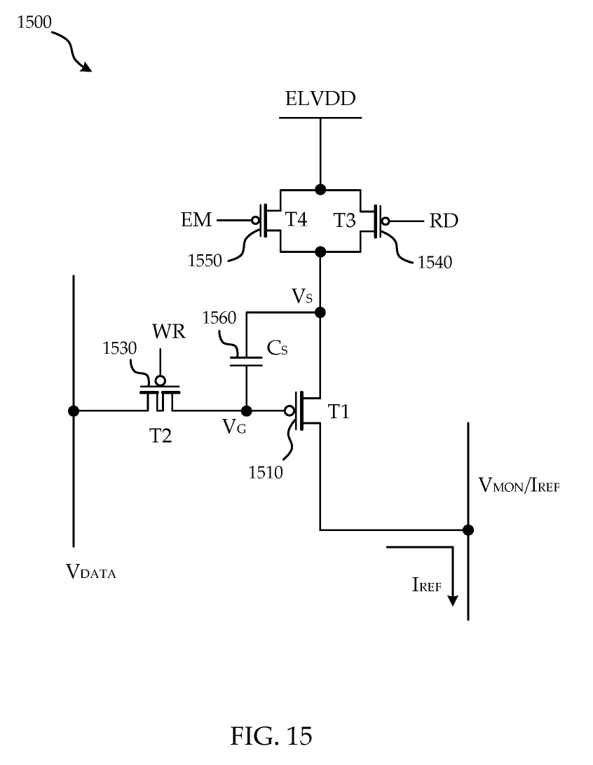

With reference to FIG. 15, the structure of a four transistor, single capacitor (4T1C) reference current source 1500 according to an embodiment will now be described. The 4T1C reference current source 1500 corresponds, for example, to a source 155a of the display system 150 depicted in FIG. 1 or a source 1072 depicted in FIG. 10. The 4T1C reference current source 1500 depicted in FIG. 15 is based on NMOS transistors. It should be understood that variations of this source and its functioning are contemplated and include different types of transistors (PMOS, NMOS, or CMOS) and different semiconductor materials (e.g. LTPS, Metal Oxide, etc.).

The 4T1C reference current source 1500 includes a driving transistor 1510 (T1), a first switch transistor 1530 (T2), a second switch transistor 1540 (T3), a third switch transistor 1550 (T4), and a storage capacitor 1560 (C_{S}). Each of the driving transistor 1510, the first switch transistor 1530, the second switch transistor 1540, and the third switch transistor 1550 having first, second, and gate terminals, and the storage capacitor 1560 having first and second terminals.

The gate terminal of the driving transistor 1510 is coupled to a first terminal of the storage capacitor 1560, while the first terminal of the driving transistor 1510 is coupled to the second terminal of the storage capacitor 1560, and the second terminal of the driving transistor 1510 is coupled to a monitor/reference current line V_{MON}/I_{REF}. The gate terminal of the first switch transistor 1530 is coupled to a write signal line (WR), while the first terminal of the first switch transistor 1530 is coupled to a data signal line (V_{DATA}), and the second terminal of the first switch transistor 1530 is coupled to the gate terminal of the driving transistor 1510. A node common to the gate terminal of the driving transistor 1510 and the storage capacitor 1560 as well as the first switch transistor 1530 is labelled by its voltage V_{G} in the figure. The gate terminal of the second switch transistor 1540 is coupled to a read signal line (RD), while the first terminal of the second switch transistor 1540 is coupled to a reference potential (ELVDD), and the second terminal of the second switch transistor 1540 is coupled to the second terminal of the storage capacitor 1560. The gate terminal of the third switch transistor 1550 is coupled to an emission signal line (EM), while the first terminal of the third switch transistor 1550 is coupled to ELVDD, and the second terminal of the third switch transistor 1550 is coupled to the second terminal of the storage capacitor 1560. A node common to the second terminal of the storage capacitor 1560, the driving transistor 1510, the second switch transistor 1540, and the third switch transistor 1550 is labelled by its voltage Vs in the figure.

The functioning of the 4T1C reference current source 1500 will be described in connection with the timing diagram of FIG. 17 discussed hereinbelow.

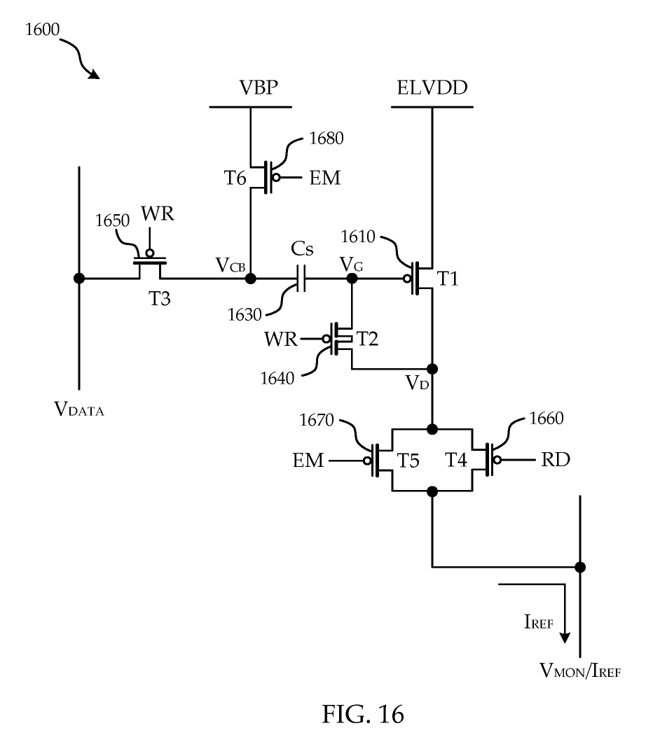

With reference to FIG. 16, the structure of a six transistor, single capacitor (6T1C) reference current source 1600 according to an embodiment will now be described. The 6T1C reference current source 1600 corresponds, for example, to a source 155a of the display system 150 depicted in FIG. 1 or a source 1072 depicted in FIG. 10. The 6T1C reference current source 1600 depicted in FIG. 16 is based on NMOS transistors. It should be understood that variations of this source and its functioning are contemplated and include different types of transistors (PMOS, NMOS, or CMOS) and different semiconductor materials (e.g., LTPS, Metal Oxide, etc.).

The 6T1C reference current source 1600 includes a driving transistor 1610 (T1), a storage capacitor 1630 (C_{S}), a first switch transistor 1640 (T2), a second switch transistor 1650 (T3), a third switch transistor 1660 (T4), a fourth switch transistor 1670 (T5), and a fifth switch transistor 1680 (T6). Each of the driving transistor 1610, the first switch transistor 1640, the second switch transistor 1650, the third switch transistor 1660, the fourth switch transistor 1670, and the fifth switch transistor 1680, having first, second, and gate terminals, and the storage capacitor 1630 having first and second terminals.

The gate terminal of the driving transistor 1610 is coupled to a first terminal of the storage capacitor 1630, while the first terminal of the driving transistor 1610 is coupled to a reference potential (ELVSS), and the second terminal of the driving transistor 1610 is coupled to the first terminal of the third switch transistor 1660. The gate terminal of the third switch transistor 1660 is coupled to a read signal line (RD) and the second terminal of the third switch transistor 1660 is coupled to a monitor/reference current line V_{MON}/I_{REF}. The gate terminal of the fourth switch transistor 1670 is coupled to an emission signal line (EM), while the first terminal of the fourth switch transistor 1670 is coupled to the first terminal of the third switch transistor 1660, and the second terminal of the fourth switch transistor 1670 is coupled to the second terminal of the third switch transistor 1660. The gate terminal of the first switch transistor 1640 is coupled to a write signal line (WR), while the first terminal of the first switch transistor 1640 is coupled to the first terminal of the storage capacitor 1630, and the second terminal of the first switch transistor 1640 is coupled to the first terminal of the third switch transistor 1660. The gate terminal of the second switch transistor 1650 is coupled to the write signal line (WR), while the first terminal of the second switch transistor 1650 is coupled to a data signal line (V_{DATA}), and the second terminal of the second switch transistor 1650 is coupled to the second terminal of the storage capacitor 1630. A node common to the gate terminal of the driving transistor 1610 and the storage capacitor 1630 as well as the first switch transistor 1640 is labelled by its voltage V_{G} in the figure. The gate terminal of the fifth switch transistor 1680 is coupled to the emission signal line (EM), while the first terminal of the fifth switch transistor 1680 is coupled to VBP, and the second terminal of the fifth switch transistor 1680 is coupled to the second terminal of the storage capacitor 1630. A node common to the second terminal of the storage capacitor 1630, the second switch transistor 1650, and the fifth switch transistor 1680 is labelled by its voltage V_{CB} in FIG. 16.

The functioning of the 6T1C reference current source 1600 will be described in connection with the timing diagram of FIG. 17 discussed hereinbelow.

With reference also to FIG. 17, an example of a reference row timing 1700 for the 4T1C reference current sink 1300 depicted in FIG. 13, the 6T1C reference current sink 1400 depicted in FIG. 14, the 4T1C reference current source 1500 depicted in FIG. 15, and the 6T1C reference current source 1600 depicted in FIG. 16 will now be described. All of these current sinks and sources 1300, 1400, 1500, 1600, use the same control signals (EM, WR, RD) and similar timing as the active rows, making them convenient for integration in the display panel for example at the first or the last row of the display panel. It should be noted that since the pixel circuits, which are current biased during programming, use as their input the bias current provided by the current sources (or sinks) and since after those sources and sinks themselves have been programmed, appropriate delays and synchronization is used to ensure programming of the sources and sinks occur at times when bias currents are not needed by the pixels and to ensure provision of biasing currents at times when required by the pixels.

The complete display timing 1700 occurs typically once per frame and includes programming cycle 1702, a calibration cycle 1704, a settling cycle 1706, and an emission cycle 1708. During the programming cycle 1702 the read signal (RD), and write signal (WR) are held low while the emission (EM) signal is held high. The emission signal (EM) is held high throughout the programming, calibration, and settling cycles 1202, 1204, 1206 for the entire duration thereof T_{EM}.

For the 4T1C reference current sink 1300 depicted in FIG. 13, during the programming cycle 1702, the first switch transistor 1330 and the second switch transistor 1340 are both on. The voltage of the storage capacitor 1360 and therefore the voltage V_{SG} of the driving transistor 1310 is charged to a value of V_{MON}−V_{DATA} where V_{MON} is a voltage of the monitor line and V_{DATA} is a voltage of the data line. These voltages are set in accordance with a desired programming voltage for causing the reference current sink 1300 to generate a reference current at a desired level.

At the beginning of the calibration cycle 1704, the read line (RD) goes high to turn off the second switch transistor 1340 to discharge some of the voltage (charge) of the storage capacitor 1360 through the driving transistor 1310. The amount discharged is a function of the characteristics of the driving transistor 1310. For example, if the driving transistor 1310 is “strong,” the discharge occurs relatively quickly and relatively more charge is discharged from the storage capacitor 1360 through the driving transistor 1310 during the fixed duration T_{IPC} of the calibration cycle 1704. On the other hand, if the driving transistor 1310 is “weak,” the discharge occurs relatively slowly and relatively less charge is discharged from the storage capacitor 1360 through the driving transistor 1310 during the calibration cycle 1704. As a result, the voltage (charge) stored in the storage capacitor 1360 is reduced comparatively more for relatively strong driving transistors versus comparatively less for relatively weak driving transistors, thereby providing some compensation for non-uniformity and variations in the reference currents being provided across the display whether due to variations in fabrication or variations in degradation over time.

After the calibration cycle 1704, a settling cycle 1706 is performed prior to the emission. During the settling cycle 1706 the second and third switch transistors 1340, 1350 remain off, while the write signal (WR) goes high to also turn off the first switch transistor 1330. After completion of the duration of the settling cycle 1706 at the start of the emission cycle 1708, the emission signal (EM) goes low turning on the third switch transistor 1350 allowing reference current I_{REF} to be provided to the monitor/reference current line according to the calibrated stored voltage on the storage capacitor 1360.

For the 6T1C reference current sink 1400 depicted in FIG. 14, during the programming cycle 1702 the first switch transistor 1440, the second switch transistor 1450, and the third switch transistor 1460 are all on. The voltage of the storage capacitor 1430 V_{CS} is charged to a value of V_{CB}−V_{G}=V_{DATA}−(V_{MON}−V_{SG}(T1)) V_{DATA}−V_{MON}+Vₜₕ(T1), where V_{DATA} is a voltage on the data line, V_{MON} is the voltage on the monitor/reference current line, V_{SG}(T1) the voltage across the gate terminal and the first terminal of the driving transistor 1410, and Vₜₕ(T1) is a threshold voltage of the driving transistor 1410. Here V_{DATA} is set taking into account a desired programming voltage for causing the reference current sink 1400 to generate a reference current at a desired level.

At the beginning of the calibration cycle 1704, the read line (RD) goes high to turn off the third switch transistor 1460 to discharge some of the voltage (charge) of the storage capacitor 1430 through the driving transistor 1410. The amount discharged is a function of the characteristics of the driving transistor 1410. For example, if the driving transistor 1410 is “strong”, the discharge occurs relatively quickly and relatively more charge is discharged from the storage capacitor 1430 through the driving transistor 1410 during the fixed duration T_{IPC} of the calibration cycle 1704. On the other hand, if the driving transistor 1410 is “weak,” the discharge occurs relatively slowly and relatively less charge is discharged from the storage capacitor 1430 through the driving transistor 1410 during the calibration cycle 1704. As a result, the voltage (charge) stored in the storage capacitor 1430 is reduced comparatively more for relatively strong driving transistors versus comparatively less for relatively weak driving transistors, thereby providing some compensation for non-uniformity and variations in the current sinks 1400 across the display whether due to variations in fabrication or variations in degradation over time.

After the calibration cycle 1704, a settling cycle 1706 is performed prior to the emission cycle 1708. During the settling cycle 1706 the third, fourth, and fifth switch transistors 1460, 1470, and 1480 remain off, while the write signal (WR) goes high to also turn off the first and second switch transistors 1440, 1450. After completion of the duration of the settling cycle 1706 at the start of the emission cycle 1708, the emission signal (EM) goes low turning on the fourth and fifth switch transistors 1470, 1480. This causes the driving transistor 1410 to be driven with a voltage V_{SG}=V_{MON}−V_{G}=V_{MON}−(VBP−V_{CS})=V_{MON}−VBP+V_{DATA}−V_{MON}+Vₜₕ(T1)=V_{DATA}+Vₜₕ(T1)−VBP. This allows reference current I_{REF} to be provided to the monitor/reference current line according to the calibrated stored voltage on the storage capacitor 1430, and which is also a function of the threshold voltage Vₜₕ(T1) of the driving transistor 1410 and which is independent of V_{MON} and independent of V_{DD}.

For the 4T1C reference current source 1500 depicted in FIG. 15, during the programming cycle 1702, the first switch transistor 1530 and the second switch transistor 1540 are both on. The voltage of the storage capacitor 1560 and therefore the voltage V_{SG} of the driving transistor 1510 is charged to a value of V_{DD}− V_{DATA} where V_{DD} is a voltage of the reference potential ELVDD line and V_{DATA} is a voltage of the data line. At least one of these voltages are set in accordance with a desired programming voltage for causing the reference current source 1500 to generate a reference current at a desired level.

At the beginning of the calibration cycle 1704, the read line (RD) goes high to turn off the second switch transistor 1540 to discharge some of the voltage (charge) of the storage capacitor 1560 through the driving transistor 1510. The amount discharged is a function of the characteristics of the driving transistor 1510. For example, if the driving transistor 1510 is “strong,” the discharge occurs relatively quickly and relatively more charge is discharged from the storage capacitor 1560 through the driving transistor 1510 during the fixed duration T_{IPC} of the calibration cycle 1704. On the other hand, if the driving transistor 1510 is “weak,” the discharge occurs relatively slowly and relatively less charge is discharged from the storage capacitor 1560 through the driving transistor 1510 during the calibration cycle 1704. As a result, the voltage (charge) stored in the storage capacitor 1560 is reduced comparatively more for relatively strong driving transistors versus comparatively less for relatively weak driving transistors, thereby providing some compensation for non-uniformity and variations in the reference currents being provided across the display whether due to variations in fabrication or variations in degradation over time.

After the calibration cycle 1704, a settling cycle 1706 is performed prior to the emission cycle. During the settling cycle 1706 the second and third switch transistors 1540, 1550 remain off, while the write signal (WR) goes high to also turn off the first switch transistor 1530. After completion of the duration of the settling cycle 1706 at the start of the emission cycle 1708, the emission signal (EM) goes low turning on the third switch transistor 1550 allowing reference current I_{REF} to be provided to the monitor/reference current line according to the calibrated stored voltage on the storage capacitor 1560.

For and the 6T1C reference current source 1600 depicted in FIG. 16, during the programming cycle 1702 the first switch transistor 1640, the second switch transistor 1650, and the third switch transistor 1660 are all on. The voltage of the storage capacitor 1630 V_{CS} is charged to a value of V_{CB}−V_{G}=V_{DATA}−(V_{DD}−V_{SG}(T1))≈V_{DATA}−V_{DD}+Vₜₕ(T1), where V_{DATA} is a voltage on the data line, V_{DD} is the voltage of the reference potential ELVDD, V_{SG}(T1) the voltage across the gate terminal and the first terminal of the driving transistor 1610, and Vₜₕ(T1) is a threshold voltage of the driving transistor 1610. Here V_{DATA} is set taking into account a desired programming voltage for causing the reference current source 1600 to generate a reference current at a desired level.

At the beginning of the calibration cycle 1704, the read line (RD) goes high to turn off the third switch transistor 1660 to discharge some of the voltage (charge) of the storage capacitor 1630 through the driving transistor 1610. The amount discharged is a function of the characteristics of the driving transistor 1610. For example, if the driving transistor 1610 is “strong,” the discharge occurs relatively quickly and relatively more charge is discharged from the storage capacitor 1630 through the driving transistor 1610 during the fixed duration T_{IPC} of the calibration cycle 1704. On the other hand, if the driving transistor 1610 is “weak,” the discharge occurs relatively slowly and relatively less charge is discharged from the storage capacitor 1630 through the driving transistor 1610 during the calibration cycle 1704. As a result, the voltage (charge) stored in the storage capacitor 1630 is reduced comparatively more for relatively strong driving transistors versus comparatively less for relatively weak driving transistors, thereby providing some compensation for non-uniformity and variations in the current sources 1600 across the display whether due to variations in fabrication or variations in degradation over time.

After the calibration cycle 1704, a settling cycle 1706 is performed prior to the emission cycle 1708. During the settling cycle 1706 the third, fourth, and fifth switch transistors 1660, 1670, and 1680 remain off, while the write signal (WR) goes high to also turn off the first and second switch transistors 1640, 1650. After completion of the duration of the settling cycle 1706 at the start of the emission cycle 1708, the emission signal (EM) goes low turning on the fourth and fifth switch transistors 1670, 1680. This causes the driving transistor 1610 to be driven with a voltage V_{SG}=V_{DD}−V_{G}=V_{DD}−(VBP−V_{CS})=V_{DD}−VBP+V_{DATA}−V_{DD}+Vₜₕ(T1)=V_{DATA}+Vₜₕ(T1)−VBP. This allows reference current I_{REF} to be provided to the monitor/reference current line according to the calibrated stored voltage on the storage capacitor 1630, and which is also a function of the threshold voltage Vₜₕ(T1) of the driving transistor 1610 and which is independent of V_{DD}.

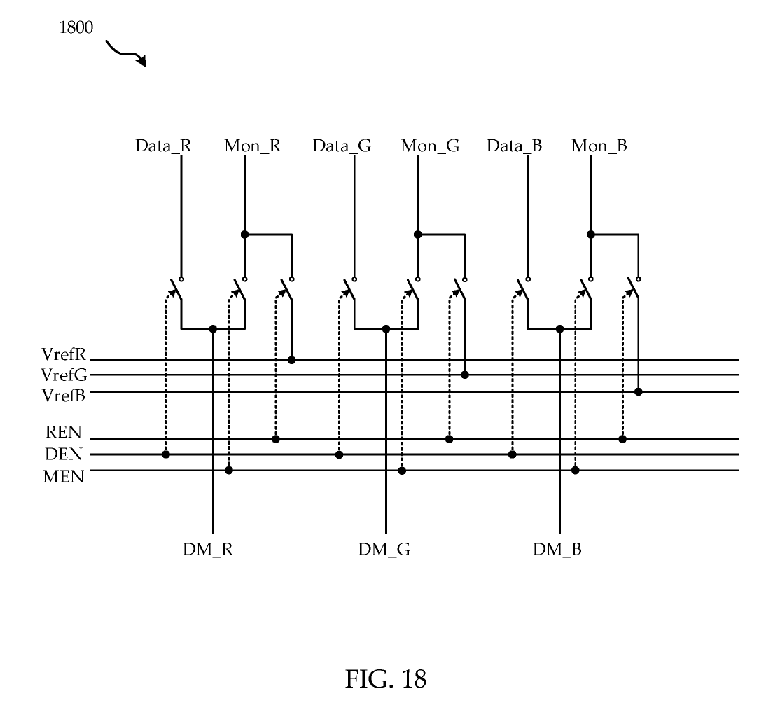

With reference to FIG. 18, on-panel multiplexing 1800 of data lines 122 and monitor lines 128 will now be discussed. A driver chip, e.g. 104, provides driver signals over data/monitor lines DM_R, DM_G, and DM_B for red, green, and blue pixels of, for example, a column. Each of these lines is connected via two switches, e.g. 1801 and 1802 for DM_R, to a separate respective data and monitor lines. For example, DM_R is coupled to Data_R and Mon_R for red subpixels, DM_G is coupled to Data_G and Mon_G for green subpixels, and DM_B is coupled to Data_B and Mon_B for blue subpixels. The switches, e.g. 1801 and 1802, demultiplexing the DM_X signals on the Data_X and Mon_X lines and are controlled respectively by a data enable (DEN) signal line (corresponding to the WR signal described herein) and a monitor enable (MEN) signal line (corresponding to the RD signal described herein). Each monitor line Mon_X may also be connected via an additional switch, e.g. 1803, to a separate reference voltage V_{REF} and/or I_{REF}, as in FIGS. 10 and 11. For example: MON_R is coupled to VrefR, MON_G is coupled to VrefG, and MON_B is coupled to VrefB. These respective additional switches, e.g. 1803, coupling the monitor lines 128 to the respective reference voltages are controlled by a reset enable (REN) signal line (corresponding to the RST signal described herein). The multiplexing provides a reduction in the I/O count of the driver chip 104. Accordingly, any display system including a plurality of pixels with both data lines 122 and monitor lines 128 may be comprise the multiplexed line system of the present invention.

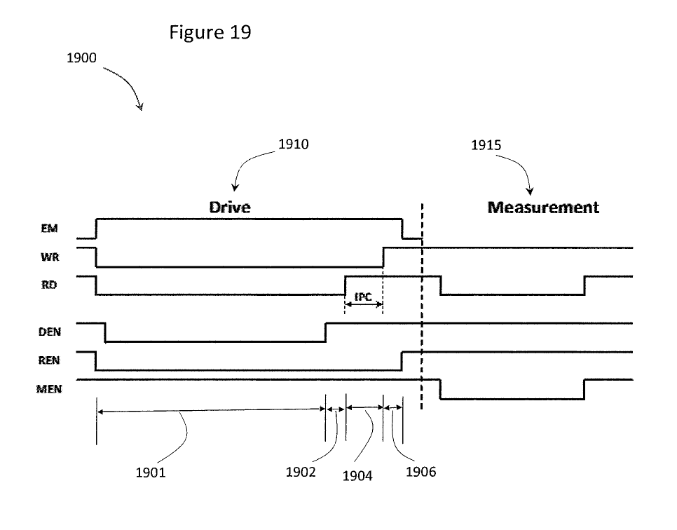

With reference also to FIG. 19, an example of a multiplexed display timing 1900 for the 4T1C pixel circuit 1000 depicted in FIG. 10 and the 6T1C pixel circuit 1100 depicted in FIG. 11 according to the data and monitor lines of FIG. 18, will now be described. For a multiplexed signal line DM_R, a Driving stage 1910 is executed first (if needed) and then, once the pixel is programmed for measurement purposes, the DEN signal for the first switch 1801 is turned off, and a measurement stage 1915 is started with a MEN signal turning on the second switch 1802.

The complete display timing 1900 occurs typically once per frame, and may include first and second programming cycles 1901, 1902, a calibration cycle 1904, a settling cycle 1906 during a drive stage 1910. The second programming cycle 1902, the calibration cycle 1904, and the settling cycle 1906 are not necessary for all embodiments, and included herein for completeness. Prior to, during or after an emission cycle 1908, and during the duration T_{MS}, a measurement mode 1915, e.g. for the current/charge, is observed on the monitor line V_{MON} or Mon_R, Mon_G and Mon_B. Activation of the EM signal may be pixel-dependent during measurement. For example, for 4T pixel of FIG. 10, EM and WR are OFF and RD is ON during Measurement when MEN is ON. As another example, for a 6T pixel, for TFT measurement, EM is ON.

During the first programming cycle 1902 over a period T_{RST} the reset (RST) signal, read signal (RD), write signal (WR), the DEN signal, and the REN signal are held low, while the emission (EM) signal is held high. Accordingly, the switches 1801 enable the data signals to be transmitted from the driver 104, along the DM_X lines to the Data_R lines. The emission signal (EM) is held high throughout the programming, calibration, and settling cycles 1901, 1902, 1904, 1906 the entire duration thereof T_{EM}. During the second programming, calibration, settling, and emission cycles 1902, 1904, 1906, 1908, the 4T1C and 6T1C pixel circuits 1000, 1100 function as described above in connection with FIG. 5 and FIG. 7 with the exception that they may be current biased.

For the 4T1C pixel circuit 1000, during the first programming cycle 1901 a reference voltage V_{REF} may be coupled through the switches 1803 and 1074 and the second switch transistor 1040 to the node common to the storage capacitor 1060, the driving transistor 1010, and the third switch transistor 1050, to reset voltage Vs to V_{REF}. The voltage of the storage capacitor 1060 and therefore the voltage V_{SG} of the driving transistor 1010 is charged to a value of V_{REF}−V_{DATA} where V_{REF} is a voltage of the monitor line and V_{DATA} is a voltage of the data line. These voltages are set in accordance with a desired programming voltage for causing the pixel 1000 to emit light at a desired luminance according to image data. At the end of the first programming cycle 1901, the reset signal goes high, turning off the switch 1074 and disconnecting the monitor/reference current line from the reference voltage V_{REF}. After the first programming cycle 1901 the read signal RD stays low allowing the reference current I_{REF} to continue to bias the pixel 1000 during the second programming cycle 1902. To achieve a desirable level of compensation for both threshold and mobility variations, each pixel of a row is driven with a reference current I_{REF} during programming of the pixel, including during both the first and second programming cycles 1901, 1902.

For the 6T1C pixel circuit 1100, during the first programming cycle 1901 a reference voltage V_{REF} is coupled through the switches 1803 and 1194 and the third switch transistor 1160 to the node common to the first switch transistor 1140, the driving transistor 1110, and the third switch transistor 1160, and the fourth switch transistor 1170, to reset voltage V_{D} to V_{REF}, and the first switch transistor 1140, the second switch transistor 1150, and the third switch transistor 1160 are all on. The voltage of the storage capacitor 1130 V_{CS} is charged to a value of V_{CB}−V_{G}=V_{DATA}−(V_{DD}−V_{SG}(T1))−V_{DATA}−V_{DD}+Vₜₕ(T1), where V_{DATA} is a voltage on the data line, V_{DD} is the voltage of the first reference potential (also referred to as ELVDD), V_{SG}(T1) the voltage across the gate terminal and the first terminal of the driving transistor 1110, and Vₜₕ(T1) is a threshold voltage of the driving transistor 1110. Here V_{DATA} set taking into account a desired programming voltage for causing the pixel 1100 to emit light at a desired luminance according to image data.

At the end of the first programming cycle 1901, the rest (RST) signal goes high turning off the switch 1194 and disconnecting the monitor/reference current line from the reference voltage V_{REF}. After the first programming cycle 1901 the read signal 9RD) stays high allowing the reference current source 1192 I_{REF} to continue to bias the pixel 1000 during the second programming cycle 1902. To achieve a desirable level of compensation for both threshold and mobility variations, each pixel of a row is driven with the reference current I_{REF} during programming of the pixel, including during both the first and second programming cycles 1901, 1902.

For embodiments with a calibration cycle, at the beginning of the calibration cycle 1904, the DEN line goes high to turn off the first switch 1801, and the read line (RD) goes high to turn off the third switch transistor 1260 to discharge some of the voltage (charge) of the storage capacitor 1130 through the driving transistor 1110 and to stop current biasing by the bias circuit 1190. The amount discharged is a function of the characteristics of the driving transistor 1110, as hereinbefore discusses.

After the calibration cycle 1904, a settling cycle 1906 may be performed prior to the emission cycle 1908 and/or the measurement stage 1915. During the settling cycle 1906 the third, fourth, and fifth switch transistors 1160, 1170, and 1180 remain off, while the write signal (WR) goes high to also turn off the first and second switch transistors 1140, 1150. After completion of the duration of the settling cycle 1906 at the start of the emission cycle 1908, the emission signal (EM) goes low turning on the fourth and fifth switch transistors 1170, 1180. This causes the driving transistor 1110 to be driven with a voltage V_{SG}=V_{DD}−V_{G}=V_{DD}−(VBP−V_{CS})=V_{DD}−VBP+V_{DATA}−V_{DD}+Vₜₕ(T1)=V_{DATA}+Vₜₕ(T1)−VBP. This allows current to flow through the light emitting device 1120 according to the calibrated stored voltage on the storage capacitor 1130, and which is also a function of the threshold voltage Vₜₕ(T1) of the driving transistor 1110 and which is independent of V_{DD}.

Once the programming cycles 1901 and 1902, the calibration cycle 1904, and the settling cycle 1906 are completed, the measuring cycle 1915 having a duration T_{MS} may commence. At the beginning of the measuring cycle 1915, the MEN signal goes low turning on the second switch 1802, and the read signal (RD) goes low turning on the third switch transistor, e.g. 760, 1040 or 1160, to provide read access to the monitor line Mon_X. The emission signal (EM) may be kept low, and hence the third switch transistor 1050 or the fourth and fifth switch transistors 1170, 1180 may be kept on during the entire duration T_{MS} of the measurement.

For measurement of the driving transistor 710, 1010 or 1110, the programming voltage V_{SG} for the driving transistor 710, 1010 or 1110 is set to the desired level through the programming 1901 and 1902, calibration 1904, settling 1906, and emission 1908 cycles, and then during the duration T_{MS} of the measurement stage 1915 the current/charge is observed on the monitor line V_{MON}. The voltage of the second reference potential (ELVSS) is raised to a high enough level (for example to ELVDD) in order to avoid interference from the light emitting device 720, 1020 or 1120.

For measurement of the light emitting device 720, 1020 or 1120, the programming voltage V_{SG} for the driving transistor 710, 1020 or 1120 is set to the lowest possible voltage available on the data line V_{DATA}, for example a value corresponding to black-level gray-scale, through the programming 1901 and 1902, calibration 1904, settling 1906 and emission 1908 cycles, in order to avoid interfering with the current of the light emitting device 720, 1020 or 1120.

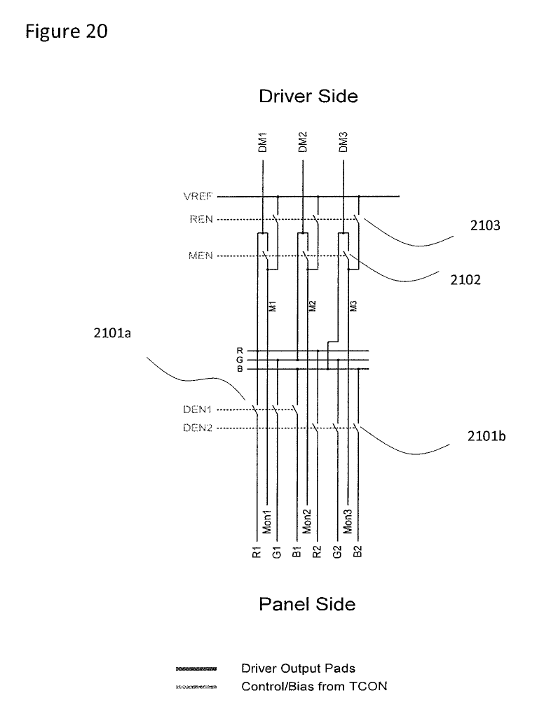

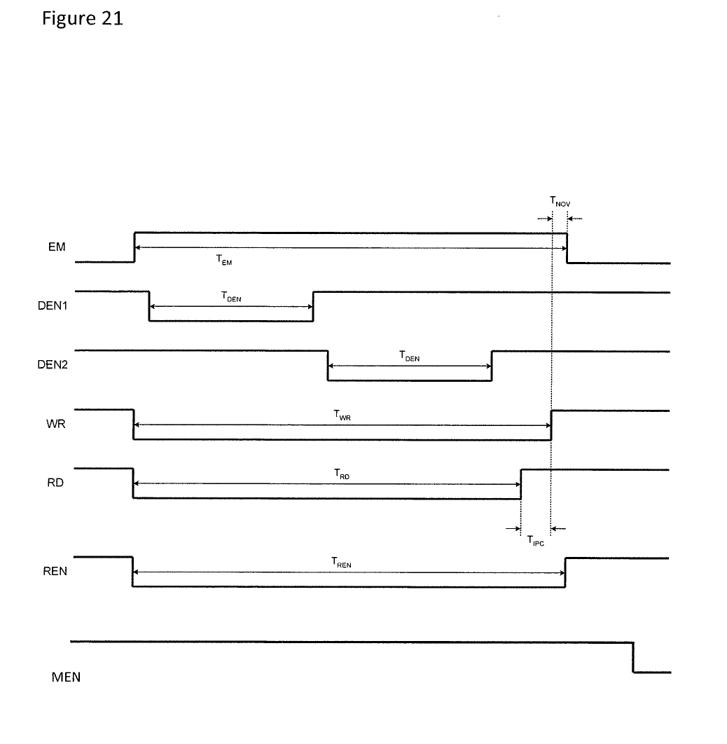

With reference to FIGS. 20 and 21, another embodiment of on-panel multiplexing 2100 of data lines 122 and monitor lines 128 will now be discussed, in which two pixels are programmed in a single cycle. A driver chip, e.g. 104, provides driver signals over data/monitor lines DM1, DM2, and DM3, each for multiplexing two red, green, and blue pixels of, e.g., a row or adjacent pixels, and each with a single monitor line Mon1, Mon2 and Mon3. Each of these lines DM1-DM3 is connected via two switches, e.g. 2101a and 2101b, to two separate respective data lines and via a third switch 2102 to one monitor line. For example, DM1 is coupled to R1, R2 and Mon1 for red subpixels, DM2 is coupled to G1, G2 and M2 for green subpixels, and DM3 is coupled to B1, B2 and Mon3 for blue subpixels. The switches, e.g. 2101a, demultiplex the data DM_X signals onto the R1, G1 and B1 lines of the first pixel, and are controlled by a first data enable (DEN1) signal line (corresponding to the WR signal described herein). The switches, e.g. 1801b demultiplex the data DM_X signals on to the R2, G2 and B2 lines of the second pixel, and are controlled by a second data enable (DEN2) signal line (corresponding to the WR signal)

Each switch 2102 is controlled by a monitor enable (MEN) signal line (corresponding to the RD signal described herein). Each monitor line Mon_X may also be connected via an additional switch, e.g. 2103, to a single reference voltage V_{REF} and/or I_{REF}, as in FIGS. 10 and 11, as opposed to separate individual V_{REF}, as in FIG. 18. These respective additional switches, e.g. 2103, coupling the monitor lines 128 to the reference voltage are controlled by a reset enable (REN) signal line (corresponding to the RST signal described herein). The multiplexing provides a reduction in the I/O count of the driver chip 104. Accordingly, any display system including a plurality of pixels with both data lines 122 and monitor lines 128 may be comprise the multiplexed line system of the present invention.

As illustrated in FIG. 21, the process is similar to the process in FIG. 19, except there is further multiplexing between alternating pixels R1, G1 and B1 with R2, G2 and B2, as the DEN1 signal is initially turned on to load the R1, G1 and B1 data onto the first pixel, and then turned off, before the DEN2 signal is turned on to load the R2, G2 and B2 data onto the second pixel, all the while the WR signal activates the Data transistor switch, e.g. 1030 or 1150. Subsequent to the DEN1, DEN2 and WR signals being turned off, the MEN signal is turned on to enable monitor signals to be transmitted over the same DM1, DM2 and DM3 lines from the Mon1, Mon2 and Mon3 lines, respectively, before, during or after activation of the emission signal EM. As above, the REN signal may be used to activate the additional switch 2103 to provide the reference voltage V_{REF} to each pixel, as hereinbefore discussed.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A display system, including a plurality of pixels, comprising:
a controller for receiving digital data indicative of information to be displayed on the display system;
a source driver for receiving data from the controller and for transmitting data signals to each pixel during a programming phase, and including a monitoring system integrated therewith for measuring a current or voltage associated with each pixel for extracting information indicative of a degradation of each pixel during a measurement phase;
a plurality of combined data/monitor lines extending from the source driver for transmitting both data and monitor signals during alternating programming and measurement phases, respectively;
a plurality of data lines extending to each pixel;
a plurality of monitor lines extending to each pixel for measuring a current or voltage associated with each pixel after the programming phase; and
a switching system for alternatively connecting each combined data/monitor line with one of the data lines and one of the monitor lines.

2. The display system according to claim 1, wherein each pixel comprises:
a light-emitting device;
a storage element coupled to one of the data lines for storing a programming signal during the programming phase;
a driving transistor switch for conveying a drive current from a first supply line to the light emitting device according to the programming signal to emit light at a desired amount of luminance during an emission phase;
an access transistor switch for selectively connecting the storage element to the source driver during the programming phase, and disconnecting the storage element from the source driver during the emission phase; and
a monitor transistor switch for selectively connecting the respective pixel to the respective monitor line.

3. The display system according to claim 1, wherein each switching system comprises a first switch for selectively connecting the respective data line to the respective combined data/monitor line; and a second switch for selectively connecting the respective monitor line to the respective combined data/monitor line.

4. The display system according to claim 3, wherein the source driver is capable of actuating the first switch and deactivating the second switch during the programming phase; and actuating the second switch and deactivating the first switch during the measurement phase.

5. The display system according to claim 3, further comprising a biasing circuit coupled to each monitor line; wherein each switching system also comprises a third switch for selectively connecting the respective biasing circuit to each monitor line.

6. The display system according to claim 5, wherein the source driver is capable of actuating the first and third switches and deactivating the second switch during the programming phase; and actuating the second switch and deactivating the first and third switches during the measurement phase.

7. The display system according to claim 1, wherein each combined data/monitor line is connected to respective first and second data lines; wherein each switching system comprises a first switch for selectively connecting the first data line to the combined data/monitor line; a second switch for selectively connecting the second data line to the combined data/monitor line; and a third switch for selectively connecting the monitor line to the combined data/monitor line.

8. The display system according to claim 7, wherein the source driver is capable of actuating the first and second switches in sequence and deactivating the third switch during the programming phase; and actuating the third switch and deactivating the first and second switches during the measurement phase.

9. The display system according to claim 7, further comprising a biasing circuit coupled to each monitor line; wherein each switching system also comprises a fourth switch for selectively connecting the biasing circuit to each monitor line.

10. The display system according to claim 9, wherein the source driver is capable of actuating the first and second switches, in sequence, actuating the fourth switch, and deactivating the third switch during the programming phase; and actuating the third switch and deactivating the first, second and fourth switches during the measurement phase.

11. The display system according to claim 2, wherein the source driver is capable of:
charging each storage element to a defined level, based on the respective data signal, during a programming cycle; and
subsequent to the programming cycle, during a calibration cycle, partially discharging the storage element as a function of characteristics of the driving transistor switch.

12. The display system of claim 11, wherein the source driver is capable of:
during the programming cycle, charging the storage element connected to a gate terminal of the driving transistor switch to include at least a threshold voltage of the driving transistor switch, such that during the emission cycle, a voltage across the source terminal and the drain terminal is a function of the threshold voltage of the driving transistor switch.

13. The display of claim 2, further comprising first and second supply lines connected to each pixel for providing a first and a second potential, respectively, thereto from a voltage supply for supplying the drive current to the light emitting device via the driving transistor switch; wherein the controller is capable of raising the second potential to equal the first potential to avoid interference from the light emitting device during the measurement phase.
